(19) United States
(12) Patent Application Publication
(10) Pub. No.: US 2019/0003554 A1
(43) Pub. Date: Jan. 3, 2019

(54) VIBRATION DAMPING DEVICE

(71) Applicant: AISIN AW CO., LTD., Anjo-shi, Aichi-ken (JP)

(72) Inventors: Hiroki NAGAI, Anjo (JP); Masaki WAJIMA, Nagoya (JP); Takao SAKAMOTO, Anjo (JP); Takuya FUKUOKA, Anjo (JP); Yoichi OI, Ama (JP)

(73) Assignee: AISIN AW CO., LTD., Anjo-shi, Aichi-ken (JP)

(21) Appl. No.: 16/069,217

(22) PCT Filed: Mar. 16, 2017
(86) PCT No.: PCT/JP2017/010801

§ 371 Date: Jul. 11, 2018

(30) Foreign Application Priority Data
Mar. 16, 2016 (JP) 2016-052598
Sep. 30, 2016 (JP) 2016-193398

(51) Int. Cl. F16F 15/14

(52) U.S. Cl. CPC F16F 15/145; F16F 15/13469

(57) ABSTRACT

A vibration damping device 20 includes: a crank member 22 that is swingable along with rotation of a driven member 15 to which torque from an engine EG is transferred; and an inertial mass body 23 coupled to the driven member 15 via the crank member 22 and swung about a center of rotation RC in conjunction with the crank member 22 along with rotation of the driven member 15. The vibration damping device 20 is designed such that an effective order q_{eff} becomes higher as the amplitude of vibration of input torque transferred from the engine EG to the driven member 15 becomes larger.

### CROSS REFERENCE TO RELATED APPLICATIONS

This application is a National Stage of International Application No. PCT/JP2017/010801 filed Mar. 16, 2017, claiming priority based on Japanese Patent Application Nos. 2016-052598 filed Mar. 16, 2016 and 2016-193398 filed Sep. 30, 2016.

### TECHNICAL FIELD

Aspects of the present disclosure relate to a vibration damping device that includes a restoring force generation member that is swingable along with rotation of a support member and an inertial mass body coupled to the support member via the restoring force generation member and swung in conjunction with the restoring force generation member along with rotation of the support member.

### BACKGROUND ART

There has hitherto been known, as a vibration damping device of this type, a vibration damping device that includes a flywheel mass body that receives a centrifugal force and that functions as a restoring force generation member and an annular inertial mass body coupled to the flywheel mass body via a connecting rod (see Patent Document 1, for example). In such a vibration damping device, when the flywheel mass body is swung along with rotation of a support member, the inertial mass body is swung in conjunction with the swinging motion of the flywheel mass body, and vibration of the support member can be damped by vibration transferred from the inertial mass body to the support member.

In addition, there has hitherto been known, as a vibration damping device, a constant-order dynamic damper that includes a ring-shaped weight and a fly weight that are mounted to a rotary body driven while receiving fluctuating torque (see Patent Document 2, for example). The constant-order dynamic damper has an interlocking mechanism constituted of a cam surface formed on the ring-shaped weight and a roller portion provided to the fly weight. When the fly weight is moved radially outward by the action of a centrifugal force, the roller portion and the cam surface contact each other. Consequently, the fly weight is slid with respect to the rotating rotary body within a predetermined range delimited in the radial direction by a guide, and the ring-shaped weight is turned (swung) within a predetermined range at least delimited coaxially with the rotary body. As a result, torque applied to the rotary body by the swinging motion of the ring-shaped weight can be caused to act without delay in synchronization with fluctuations in drive torque to damp vibration (torque fluctuations) of the rotary body.

### RELATED ART DOCUMENTS

### Patent Documents

Patent Document 1: German Patent Application Publication No. 102012212854

Patent Document 2: Japanese Patent Application Publication No. 1-312246 (JP 1-312246 A)

### SUMMARY

In vibration damping devices that include an inertial mass body or a ring-shaped weight such as those described in Patent Documents 1 and 2, good vibration damping performance can be obtained when the order of the vibration damping device coincides with the excitation order of an engine. Even if the order of the vibration damping device when the vibration angle of the inertial mass body, that is, the amplitude of vibration of input torque, is relatively small coincides with the excitation order of the engine, however, a deviation may be caused between the order of the vibration damping device and the excitation order of the engine as the amplitude of vibration of the input torque becomes larger, and the vibration damping performance may be varied.

Thus, one aspect according to the present disclosure is to improve the vibration damping performance of a vibration damping device that includes a restoring force generation member and an inertial mass body swung in conjunction with the restoring force generation member.

The present disclosure provides a vibration damping device including: a support member that rotates together with a rotary element, to which torque from an engine is transferred, about a center of rotation of the rotary element; a restoring force generation member that is coupled to the support member and that is swingable along with rotation of the support member; and an inertial mass body coupled to the support member via the restoring force generation member and swung about the center of rotation in conjunction with the restoring force generation member along with rotation of the support member, in which an order of the vibration damping device becomes higher as an amplitude of vibration of input torque transferred from the engine to the rotary element becomes larger.

In the case where the order of the vibration damping device becomes higher as the amplitude of vibration of the input torque becomes larger in this way, the order becomes lower as the amplitude of vibration of the input torque becomes smaller. In addition, the fact that the order of the vibration damping device is low when the amplitude of vibration of the input torque is small means that an equivalent mass of the vibration damping device when the amplitude of vibration of the input torque is small (in a stationary state) is large, or that an equivalent rigidity of the vibration damping device is low. That is, in the vibration damping device, the order of which becomes higher as the amplitude of vibration of the input torque becomes larger, the moment of inertia of the inertial mass body can be caused to become relatively larger by increasing the moment of inertia of the inertial mass body so as to increase the equivalent mass, or by reducing the mass (a restoring force that acts on the restoring force generation member) of the restoring force generation member so as to reduce the equivalent rigidity. The studies conducted by the inventors revealed that the degree of improvement in vibration damping performance due to such an increase in moment of inertia of the inertial mass body was sufficiently large compared to the degree of reduction in vibration damping performance due to a deviation of the order. Thus, it is possible to further improve the vibration damping performance of the vibration damping device, which includes the restoring force generation member and the inertial mass body which is swung in conjunction with the restoring force generation member, by causing the order of the vibration damping device to become higher as the amplitude of vibration of the input torque becomes larger.

### BRIEF DESCRIPTION OF THE DRAWINGS

FIG. 1 is a schematic diagram illustrating a starting device that includes a vibration damping device according to the present disclosure.

FIG. 2 is a sectional view of the starting device illustrated in FIG. 1.

FIG. 3 is a front view of the vibration damping device according to the present disclosure.

FIG. 4 is an enlarged sectional view illustrating an essential portion of the vibration damping device according to the present disclosure.

FIG. 5A is a schematic diagram illustrating operation of the vibration damping device according to the present disclosure.

FIG. 5B is a schematic diagram illustrating operation of the vibration damping device according to the present disclosure.

FIG. 5C is a schematic diagram illustrating operation of the vibration damping device according to the present disclosure.

FIG. 6 illustrates an example of the relationship between the rotational speed of an engine and torque fluctuations T_{Fluc} of an output element of a damper device according to the present disclosure.

FIG. 7 is a chart that illustrates the results of analyzing the relationship between the amplitude of vibration of torque transferred from the engine to the vibration damping device and the effective order of the vibration damping device.

FIG. 8 illustrates an example of the relationship between the rotational speed of the engine and the torque fluctuations T_{Fluc} of the output element of the damper device according to the present disclosure.

FIG. 9 is a schematic diagram illustrating still another vibration damping device according to the present disclosure.

FIG. 10 is a schematic diagram illustrating another vibration damping device according to the present disclosure.

FIG. 11 is a front view of still another vibration damping device according to the present disclosure.

FIG. 12 is an enlarged view illustrating another vibration damping device according to the present disclosure.

FIG. 13 is an enlarged sectional view illustrating an essential portion of the vibration damping device illustrated in FIG. 12.

FIG. 14 is an enlarged sectional view illustrating an essential portion of a modification of the vibration damping device illustrated in FIG. 12.

FIG. 15 is an enlarged view illustrating an essential portion of another modification of the vibration damping device illustrated in FIG. 12.

FIG. 16 is an enlarged sectional view illustrating an essential portion of a modification of the vibration damping device illustrated in FIG. 12.

FIG. 17 is a schematic diagram illustrating a modification of the damper device which includes the vibration damping device according to the present disclosure.

FIG. 18 is a schematic diagram illustrating another modification of the damper device which includes the vibration damping device according to the present disclosure.

### PREFERRED EMBODIMENTS

Now, an embodiment according to the present disclosure will be described with reference to the drawings.

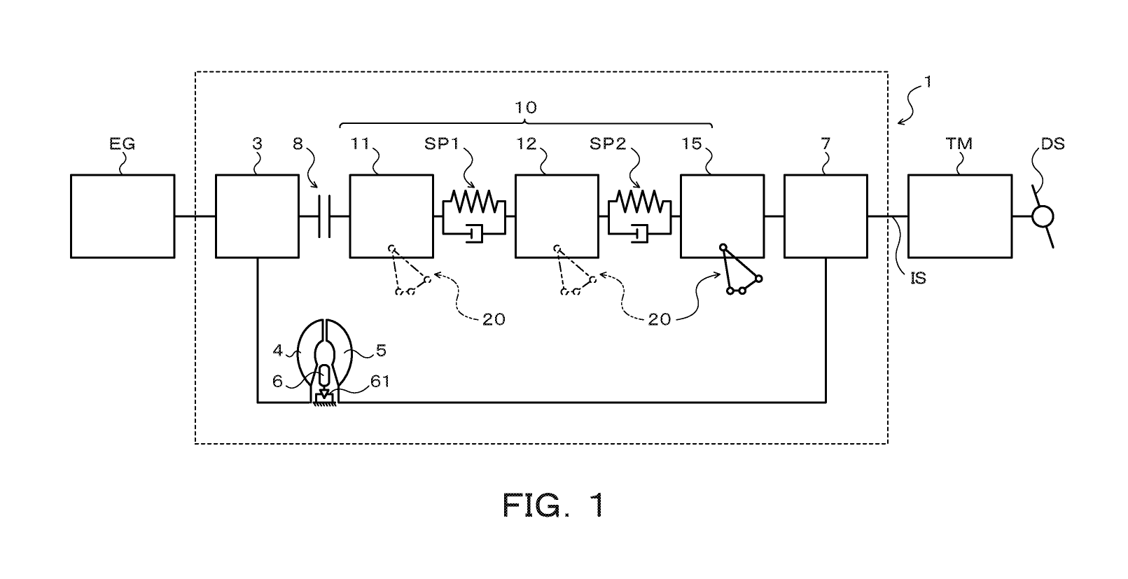

FIG. 1 is a schematic diagram illustrating a starting device 1 that includes a vibration damping device 20 according to the present disclosure. The starting device 1 illustrated in the drawing is mounted on a vehicle that includes an engine (internal combustion engine) EG that serves as a drive device, for example, and transfers power from the engine EG to drive shafts DS of the vehicle. In addition to the vibration damping device 20, the starting device 1 includes: a front cover 3 that serves as an input member coupled to a crankshaft of the engine EG; a pump impeller (input-side fluid transmission element) 4 fixed to the front cover 3 to rotate together with the front cover 3; a turbine runner (output-side fluid transmission element) 5 that is rotatable coaxially with the pump impeller 4; a damper hub 7 that serves as an output member fixed to an input shaft IS of a transmission (power transfer device) TM that is an automatic transmission (AT), a continuously variable transmission (CVT), a dual clutch transmission (DCT), a hybrid transmission, or a speed reducer; a lock-up clutch 8; a damper device 10; and so forth.

In the following description, unless specifically stated, the term “axial direction” basically indicates the direction of extension of the center axis (axis) of the starting device 1 or the damper device 10 (vibration damping device 20). In addition, unless specifically stated, the term “radial direction” basically indicates the radial direction of the starting device 1, the damper device 10, or a rotary element of the damper device 10 etc., that is, the direction of extension of a line that extends in directions (radial directions) that are orthogonal to the center axis of the starting device 1 or the damper device 10 from the center axis. Further, unless specifically stated, the term “circumferential direction” basically indicates the circumferential direction of the starting device 1, the damper device 10, or a rotary element of the damper device 10 etc., that is, a direction along the rotational direction of such a rotary element.

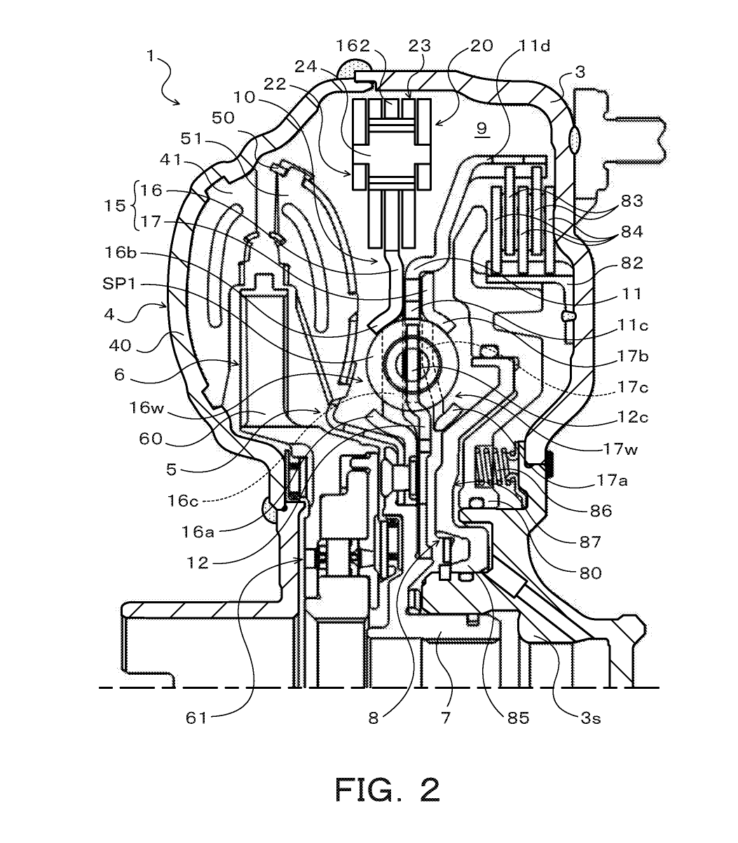

As illustrated in FIG. 2, the pump impeller 4 has a pump shell 40 tightly fixed to the front cover 3 and a plurality of pump blades 41 disposed on the inner surface of the pump shell 40. As illustrated in FIG. 2, the turbine runner 5 has a turbine shell 50 and a plurality of turbine blades 51 disposed on the inner surface of the turbine shell 50. The inner peripheral portion of the turbine shell 50 is fixed to the damper hub 7 via a plurality of rivets.

The pump impeller 4 and the turbine runner 5 face each other. A stator 6 is disposed between and coaxially with the pump impeller 4 and the turbine runner 5. The stator 6 adjusts a flow of working oil (working fluid) from the turbine runner 5 to the pump impeller 4. The stator 6 has a plurality of stator blades 60. The rotational direction of the stator 6 is set to only one direction by a one-way clutch 61. The pump impeller 4, the turbine runner 5, and the stator 6 form a torus (annular flow passage) that allows circulation of working oil, and function as a torque converter (fluid transmission apparatus) with a torque amplification function. It should be noted, however, that the stator 6 and the one-way clutch 61 may be omitted from the starting device 1, and that the pump impeller 4 and the turbine runner 5 may function as a fluid coupling.

The lock-up clutch 8 is constituted as a hydraulic multi-plate clutch, and can establish and release lock-up in which the front cover 3 and the damper hub 7, that is, the input shaft IS of the transmission TM, are coupled to each other via the damper device 10. The lock-up clutch 8 includes: a lock-up piston 80 supported by a center piece 3s, which is fixed to the front cover 3, so as to be movable in the axial direction; a drum portion 11d that serves as a clutch drum integrated with a drive member 11 which is an input element of the damper device 10; an annular clutch hub 82 fixed to the inner surface of the front cover 3 so as to face the lock-up piston 80; a plurality of first friction engagement plates (friction plates having a friction material on both surfaces) 83 fitted to spines formed on the inner peripheral surface of the drum portion 11d; and a plurality of second friction engagement plates (separator plates) 84 fitted to splines formed on the outer peripheral surface of the clutch hub 82.

The lock-up clutch 8 further includes: an annular flange member (oil chamber defining member) 85 attached to the center piece 3s of the front cover 3 so as to be positioned on the opposite side of the lock-up piston 80 from the front cover 3, that is, on the damper device 10 side with respect to the lock-up piston 80; and a plurality of return springs 86 disposed between the front cover 3 and the lock-up piston 80. As illustrated in the drawing, the lock-up piston 80 and the flange member 85 define an engagement oil chamber 87. Working oil (an engagement hydraulic pressure) is supplied to the engagement oil chamber 87 from a hydraulic control device (not illustrated). Increasing the engagement hydraulic pressure for the engagement oil chamber 87 moves the lock-up piston 80 in the axial direction so as to press the first and second friction engagement plates 83 and 84 toward the front cover 3, which can bring the lock-up clutch 8 into engagement (complete engagement or slip engagement). The lock-up clutch 8 may be constituted as a hydraulic single-plate clutch.

As illustrated in FIGS. 1 and 2, the damper device 10 includes, as rotary elements, the drive member (input element) 11 which includes the drum portion 11d, an intermediate member (intermediate element) 12, and a driven member (output element) 15. The damper device 10 further includes, as torque transfer elements, a plurality of (e.g. four each in the present embodiment) first springs (first elastic bodies) SP1 and second springs (second elastic bodies) SP2 disposed alternately at intervals in the circumferential direction on the same circumference. Arc coil springs, which are made of a metal material wound so as to have an axis that extends arcuately when no load is applied, or straight coil springs, which are made of a metal material spirally wound so as to have an axis that extends straight when no load is applied, are adopted as the first and second springs SP1 and SP2. As illustrated in the drawings, so-called double springs may be adopted as the first and second springs SP1 and SP2.

The drive member 11 of the damper device 10 is an annular member that includes the drum portion 11d on the outer peripheral side, and has a plurality of (e.g. four at intervals of 90° in the present embodiment) spring abutment portions 11c provided at intervals in the circumferential direction to extend radially inward from the inner peripheral portion. The intermediate member 12 is an annular plate-like member, and has a plurality of (e.g. four at intervals of 90° in the present embodiment) spring abutment portions 12c provided at intervals in the circumferential direction to extend radially inward from the outer peripheral portion. The intermediate member 12 is rotatably supported by the damper hub 7, and surrounded by the drive member 11 on the radially inner side of the drive member 11.

As illustrated in FIG. 2, the driven member 15 includes an annular first driven plate 16 and an annular second driven plate 17 coupled so as to rotate together with the first driven plate 16 via a plurality of rivets (not illustrated). The first driven plate 16 is constituted as a plate-like annular member, disposed in more proximity to the turbine runner 5 than the second driven plate 17, and fixed to the damper hub 7 via a plurality of rivets together with the turbine shell 50 of the turbine runner 5. The second driven plate 17 is constituted as a plate-like annular member that has an inside diameter that is smaller than that of the first driven plate 16, and the outer peripheral portion of the second driven plate 17 is fastened to the first driven plate 16 via a plurality of rivets (not illustrated).

The first driven plate 16 has: a plurality of (e.g. four in the present embodiment) spring housing windows 16w that extend arcuately and that are disposed at intervals (equal intervals) in the circumferential direction; a plurality of (e.g. four in the present embodiment) spring support portions 16a that extend along the inner peripheral edges of the respective spring housing windows 16w and that are arranged at intervals (equal intervals) in the circumferential direction; a plurality of (e.g. four in the present embodiment) spring support portions 16b that extend along the outer peripheral edges of the respective spring housing windows 16w and that are arranged at intervals (equal intervals) in the circumferential direction to face the respective spring support portions 16a in the radial direction of the first driven plate 16; and a plurality of (e.g. four in the present embodiment) spring abutment portions 16c. The plurality of spring abutment portions 16c of the first driven plate 16 are provided such that each spring abutment portion 16c is interposed between the spring housing windows 16w (spring support portions 16a and 16b) which are adjacent to each other along the circumferential direction.

The second driven plate 17 also has: a plurality of (e.g. four in the present embodiment) spring housing windows 17w that extend arcuately and that are disposed at intervals (equal intervals) in the circumferential direction; a plurality of (e.g. four in the present embodiment) spring support portions 17a that extend along the inner peripheral edges of the respective spring housing windows 17w and that are arranged at intervals (equal intervals) in the circumferential direction; a plurality of (e.g. four in the present embodiment) spring support portions 17b that extend along the outer peripheral edges of the respective spring housing windows 17w and that are arranged at intervals (equal intervals) in the circumferential direction to face the respective spring support portions 17a in the radial direction of the second driven plate 17; and a plurality of (e.g. four in the present embodiment) spring abutment portions 17c. The plurality of spring abutment portions 17c of the second driven plate 17 are provided such that each spring abutment portion 17c is interposed between the spring housing windows 17w (spring support portions 17a and 17b) which are adjacent to each other along the circumferential direction. In the present embodiment, as illustrated in FIG. 2, the drive member 11 is rotatably supported by the outer peripheral surface of the second driven plate 17 which is supported by the damper hub 7 via the first driven plate 16. Consequently the drive member 11 is aligned with respect to the damper hub 7.

With the damper device 10 in the attached state, the first and second springs SP1 and SP2 are each disposed between the spring abutment portions 11c of the drive member 11 which are adjacent to each other so that the first and second springs SP1 and SP2 are arranged alternately along the circumferential direction of the damper device 10. In addition, the spring abutment portions 12c of the intermediate member 12 are each provided between the first and second springs SP1 and SP2, which are disposed between the spring abutment portions 11c adjacent to each other and which are paired with each other (act in series with each other), so that the spring abutment portions 12c each abut against the end portions of such first and second springs SP1 and SP2. Consequently, with the damper device 10 in the attached state, a first end portion of each first spring SP1 abuts against the corresponding spring abutment portion 11c of the drive member 11, and a second end portion of each first spring SP1 abuts against the corresponding spring abutment portion 12c of the intermediate member 12. With the damper device 10 in the attached state, in addition, a first end portion of each second spring SP2 abuts against the corresponding spring abutment portion 12c of the intermediate member 12, and a second end portion of each second spring SP2 abuts against the corresponding spring abutment portion 11c of the drive member 11.

Meanwhile, as seen from FIG. 2, the plurality of spring support portions 16a of the first driven plate 16 each support (guide) side portions of the corresponding set of first and second springs SP1 and SP2 on the turbine runner 5 side from the inner peripheral side. In addition, the plurality of spring support portions 16b each support (guide) the side portions of the corresponding set of first and second springs SP1 and SP2 on the turbine runner 5 side from the outer peripheral side. Further, as seen from FIG. 2, the plurality of spring support portions 17a of the second driven plate 17 each support (guide) side portions of the corresponding set of first and second springs SP1 and SP2 on the lock-up piston 80 side from the inner peripheral side. In addition, the plurality of spring support portions 17b each support (guide) the side portions of the corresponding set of first and second springs SP1 and SP2 on the lock-up piston 80 side from the outer peripheral side.

In addition, with the damper device 10 in the attached state, as with the spring abutment portions 11c of the drive member 11, the spring abutment portions 16c and the spring abutment portions 17c of the driven member 15 are provided between the first and second springs SP1 and SP2, which are not paired with each other (do not act in series with each other), to abut against the end portions of such first and second springs SP1 and SP2. Consequently, with the damper device 10 in the attached state, the first end portion of each first spring SP1 also abuts against the associated spring abutment portions 16c and 17c of the driven member 15, and the second end portion of each second spring SP2 also abuts against the associated spring abutment portions 16c and 17c of the driven member 15. As a result, the driven member 15 is coupled to the drive member 11 via the plurality of first springs SP1, the intermediate member 12, and the plurality of second springs SP2, and the first and second springs SP1 and SP2 which are paired with each other are coupled in series with each other via the spring abutment portion 12c of the intermediate member 12 between the drive member 11 and the driven member 15. In the present embodiment, the distance between the axis of the starting device 1 and the damper device 10 and the axis of the first springs SP1 and the distance between the axis of the starting device 1 etc. and the axis of the second springs SP2 are equal to each other.

The damper device 10 according to the present embodiment further includes: a first stopper that restricts relative rotation between the intermediate member 12 and the driven member 15 and deflection of the second springs SP2; and a second stopper that restricts relative rotation between the drive member 11 and the driven member 15. The first stopper is configured to restrict relative rotation between the intermediate member 12 and the driven member 15 when torque transferred from the engine EG to the drive member 11 has reached torque (first threshold) T1 that is determined in advance and that is less than torque T2 (second threshold) corresponding to a maximum torsional angle θmax of the damper device 10. In addition, the second stopper is configured to restrict relative rotation between the drive member 11 and the driven member 15 when torque transferred to the drive member 11 has reached the torque T2 corresponding to the maximum torsional angle θmax. Consequently, the damper device 10 has damping characteristics in two stages. The first stopper may be configured to restrict relative rotation between the drive member 11 and the intermediate member 12 and deflection of the first springs SP1. The damper device 10 may also be provided with: a stopper that restricts relative rotation between the drive member 11 and the intermediate member 12 and deflection of the first springs SP1; and a stopper that restricts relative rotation between the intermediate member 12 and the driven member 15 and deflection of the second springs SP2.

The vibration damping device 20 is coupled to the driven member 15 of the damper device 10, and disposed inside a fluid transmission chamber 9 filled with working oil. As illustrated in FIGS. 2 to 4, the vibration damping device 20 includes: the first driven plate 16 which serves as a support member (first link); a plurality of (e.g. four in the present embodiment) crank members 22 that serve as a restoring force generation member (second link) rotatably coupled to the first driven plate 16 via respective first coupling shafts 21; a single annular inertial mass body (third link) 23; and a plurality of (e.g. four in the present embodiment) second coupling shafts 24 that couple the respective crank members 22 and the inertial mass body 23 so as to be rotatable relative to each other.

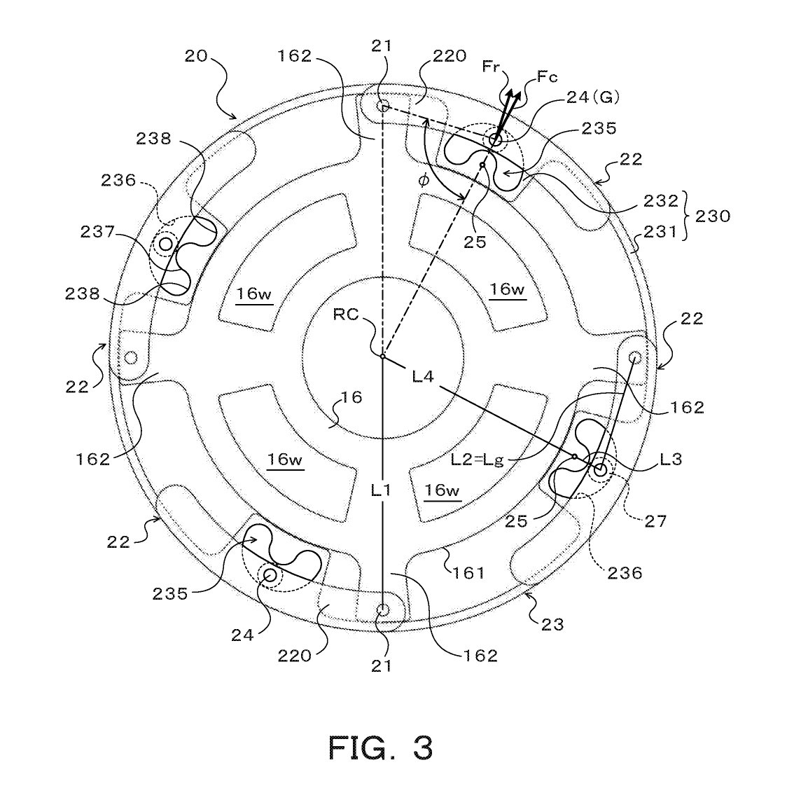

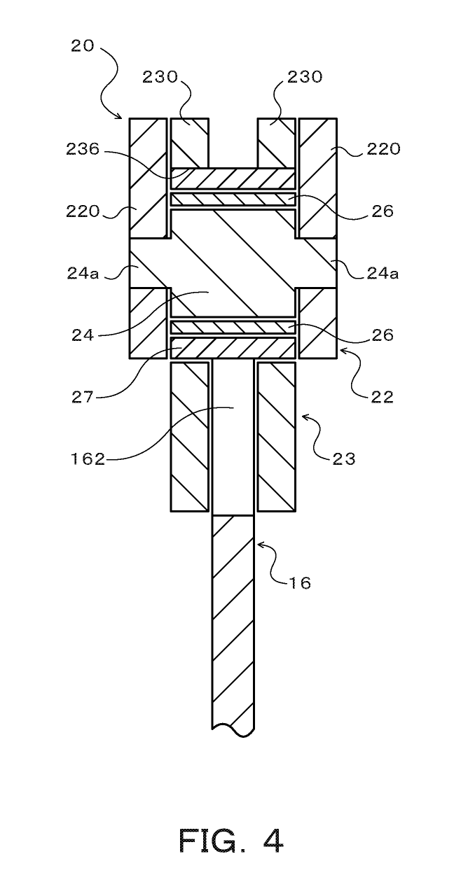

As illustrated in FIG. 3, the first driven plate 16 has a plurality of (e.g. four in the present embodiment) projecting support portions 162 formed at intervals (equal intervals) in the circumferential direction to project radially outward from an outer peripheral surface 161. As illustrated in the drawing, first end portions of the crank members 22 are rotatably coupled to the respective projecting support portions 162 of the first driven plate 16 via the first coupling shafts 21 (see FIG. 3). In the present embodiment, as illustrated in FIG. 4, each of the crank members 22 has two plate members 220. The plate members 220 are formed from a metal plate so as to have an arcuate planar shape. In the present embodiment, the radius of curvature of the outer peripheral edges of the plate members 220 is determined to be the same as the radius of curvature of the outer peripheral edge of the inertial mass body 23.

The two plate members 220 face each other in the axial direction of the damper device 10 via the associated projecting support portion 162 and the inertial mass body 23, and are coupled to each other via the first coupling shaft 21. In the present embodiment, the first coupling shafts 21 are each a rivet inserted through a coupling hole (circular hole) that serves as sliding bearing portion formed in the projecting support portion 162 of the first driven plate 16 and coupling holes (circular holes) that serve as sliding bearing portions formed in the plate members 220, and both ends are riveted. Consequently, the first driven plate 16 (driven member 15) and each of the crank members 22 constitute a turning pair. Each first coupling shaft 21 may be inserted through coupling holes that serve as sliding bearing portions formed in the projecting support portion 162 and one of the two plate members 220, and supported (fitted or fixed) by the other. A rolling bearing such as a ball bearing may be disposed in at least one of a space between the plate member 220 and the first coupling shaft 21 and a space between the projecting support portion 162 and the first coupling shaft 21.

The inertial mass body 23 includes two annular members 230 formed from a metal plate. The weight of the inertial mass body 23 (two annular members 230) is determined to be sufficiently larger than the weight of one crank member 22. As illustrated in FIGS. 3 and 4, the annular members 230 each have: a short cylindrical (annular) main body 231; and a plurality of (e.g. four in the present embodiment) projecting portions 232 provided at intervals (equal intervals) in the circumferential direction to project radially inward from the inner peripheral surface of the main body 231. The two annular members 230 are coupled to each other via a fixing member (not illustrated) such that the projecting portions 232 face each other in the axial direction of the annular members 230.

The projecting portions 232 are each provided with a guide portion 235 that guides the second coupling shaft 24 which couples the crank member 22 and the inertial mass body 23 to each other. The guide portion 235 is an opening portion that extends arcuately, and includes: a guide surface 236 in a recessed curved surface shape; a support surface 237 in a projecting curved surface shape provided on the inner side (a portion close to the center of the annular members 230) in the radial direction of the annular member (first driven plate 16) with respect to the guide surface 236 to face the guide surface 236; and two stopper surfaces 238 that are continuous with the guide surface 236 and the support surface 237 on both sides of the guide surface 236 and the support surface 237. The guide surface 236 is a recessed circular columnar surface that has a constant radius of curvature. The support surface 237 is a projecting curved surface that extends arcuately. The stopper surfaces 238 are each a recessed curved surface that extends arcuately. As illustrated in FIG. 3, each guide portion 235 (the guide surface 236, the support surface 237, and the stopper surfaces 238) is formed to be transversely symmetrical with respect to a line that passes through the center of curvature of the guide surface 236 and the center of the annular members 230 (center of rotation RC of the first driven plate 16). In the vibration damping device 20, a line that passes through the center of curvature of the guide surface 236 and that is orthogonal to the projecting portion 232 (annular members 230) is determined as a virtual axis (third coupling shaft) 25, the relative position of which with respect to the two annular members 230, that is, the inertial mass body 23, is invariable (which is not movable with respect to the inertial mass body 23).

The second coupling shaft 24 is formed in a solid (or hollow) round bar shape, and has two protruding portions 24a in a round bar shape, for example, that project toward the outer side in the axial direction from both ends of the second coupling shaft 24. As illustrated in FIG. 4, the two protruding portions 24a of the second coupling shaft 24 are fitted (fixed) to respective coupling holes (circular holes) formed in the plate members 220 of the crank member 22. In the present embodiment, the coupling hole of the plate member 220, with which the protruding portion 24a is fitted, is formed in the plate member 220 such that the center of the coupling hole extends coaxially with a line that passes through a center of gravity G of the crank member 22 (around the center portion of the plate member 220 in the longitudinal direction). Consequently, the length from the center of the first coupling shaft 21, which couples the first driven plate 16 (projecting support portion 162) and the crank member 22 to each other, to the center of gravity G of the crank member 22 coincides with the interaxial distance (center distance) between the first coupling shaft 21 and the second coupling shaft 24, which couples the crank member 22 and the inertial mass body 23 to each other. In addition, the other end portion of the crank member 22 (plate members 220) is positioned on the opposite side of the second coupling shaft 24 from the first coupling shaft 21. The protruding portions 24a of the second coupling shaft 24 may be inserted through coupling holes (circular holes) that serve as sliding bearing portions formed in the plate members 220 of the crank member 22. That is, the second coupling shaft 24 may be rotatably supported from both sides by the two plate members, that is, the crank member 22. Further, a rolling bearing such as a ball bearing may be disposed between the plate member 220 and the protruding portion 24a of the second coupling shaft 24.

As illustrated in FIG. 4, the second coupling shaft 24 rotatably supports a cylindrical outer ring 27 via a plurality of rollers (rolling bodies) 26. The outside diameter of the outer ring 27 is determined to be slightly smaller than the spacing between the guide surface 236 and the support surface 237 of the guide portion 235. The second coupling shaft 24 and the outer ring 27 are supported by the crank member 22, and disposed in the associated guide portion 235 of the inertial mass body 23 such that the outer ring 27 rolls on the guide surface 236. Consequently, the inertial mass body 23 is disposed coaxially with the center of rotation RC of the first driven plate 16 and so as to be rotatable about the center of rotation RC. In addition, the plurality of rollers 26, the outer ring 27, and the second coupling shaft 24 constitute a rolling bearing. Thus, relative rotation between the crank members 22 and the inertial mass body 23 is allowed, and each of the crank members 22 and the inertial mass body 23 constitute a turning pair. A plurality of balls may be disposed between the second coupling shaft 24 and the outer ring 27 in place of the plurality of rollers 26.

In the vibration damping device 20, as discussed above, the first driven plate 16 (driven member 15) and each of the crank members 22 constitute a turning pair, and each of the crank members 22 and the second coupling shaft 24 which is guided by the guide portion 235 of the inertial mass body 23 constitute a turning pair. In addition, the inertial mass body 23 is disposed so as to be rotatable about the center of rotation RC of the first driven plate 16. Consequently, when the first driven plate 16 is rotated in one direction, each of the second coupling shafts 24 is moved in conjunction with the second link while being guided by the guide portion 235 of the inertial mass body 23 to make swinging motion (reciprocal rotational motion) about the first coupling shaft 21 while keeping the interaxial distance between the first coupling shaft 21 and the second coupling shaft 24 constant, and to make swinging motion (reciprocal rotational motion) about the virtual axis 25 while keeping the interaxial distance between the virtual axis 25 and the second coupling shaft 24 constant. That is, each of the crank members 22 makes swinging motion about the first coupling shaft 21 in accordance with movement of the second coupling shaft 24, and the virtual axis 25 and the inertial mass body 23 make swinging motion about the second coupling shaft 24 which makes movement, and make swinging motion (reciprocal rotational motion) about the center of rotation RC of the first driven plate 16. As a result, the first driven plate 16, the crank members 22, the inertial mass body 23, the first and second coupling shafts 21 and 24, and the guide portions 235 substantially constitute a four-node rotary link mechanism in which the first driven plate 16 serves as a fixed node.

In the present embodiment, further, when the interaxial distance between the center of rotation RC of the first driven plate 16 and the first coupling shaft 21 is defined as “L1”, the interaxial distance between the first coupling shaft 21 and the second coupling shaft 24 is defined as “L2”, the interaxial distance between the second coupling shaft 24 and the virtual axis 25 is defined as “L3”, and the interaxial distance between the virtual axis 25 and the center of rotation RC is defined as “L4” (see FIG. 2), the first driven plate 16, the crank members 22, the inertial mass body 23, the second coupling shafts 24, and the guide portions 235 of the inertial mass body 23 are configured to meet the relationship L1+L2>L3+L4. In the present embodiment, in addition, the interaxial distance L3 between the second coupling shaft 24 and the virtual axis 25 (the radius of curvature of the guide surface 236 minus the radius of the outer ring 27) is determined to be shorter than the interaxial distances L1, L2, and L4, and as short as possible in the range in which operation of the crank members 22 and the inertial mass body 23 is not hindered. In the present embodiment, further, the first driven plate 16 (projecting support portions 162) which serves as the first link is configured such that the interaxial distance L1 between the center of rotation RC and the first coupling shaft 21 is longer than the interaxial distances L2, L3, and L4.

Consequently, in the vibration damping device 20 according to the present embodiment, the relationship L1>L4>L2>L3 is met, and the first driven plate 16, the crank members 22, the inertial mass body 23, the first and second coupling shafts 21 and 24, and the guide portions 235 substantially constitute a double lever mechanism in which the first driven plate 16 which faces a line segment (virtual link) that connects between the second coupling shaft 24 and the virtual axis 25 serves as a fixed node. Additionally, in the vibration damping device 20 according to the present embodiment, when the length from the center of the first coupling shaft 21 to the center of gravity G of the crank member 22 is defined as “Lg”, the relationship Lg=L2 is met.

In addition, the “equilibrium state (balanced state)” of the vibration damping device 20 corresponds to a state in which the resultant force of the total of centrifugal forces that act on the constituent elements of the vibration damping device 20 and forces that act on the centers of the first and second coupling shafts 21 and 24 of the vibration damping device 20 and the center of rotation RC is zero. When the vibration damping device 20 is in the equilibrium state, as illustrated in FIG. 3, the center of the second coupling shaft 24, the center of the virtual axis 25, and the center of rotation RC of the first driven plate 16 are positioned on one line. Further, the vibration damping device 20 according to the present embodiment is configured to meet 60°≤ϕ≤120°, more preferably 70°≤ϕ≤90°, when the angle formed by the direction from the center of the first coupling shaft 21 toward the center of the second coupling shaft 24 and the direction from the center of the second coupling shaft 24 toward the center of rotation RC of the first driven plate 16 in the equilibrium state in which the center of the second coupling shaft 24, the center of the virtual axis 25, and the center of rotation RC are positioned on one line is defined as “ϕ”.

In the starting device 1 which includes the damper device 10 and the vibration damping device 20, when lock-up is released by the lock-up clutch 8, as seen from FIG. 1, torque (power) from the engine EG which serves as a motor is transferred to the input shaft IS of the transmission TM via a path that includes the front cover 3, the pump impeller 4, the turbine runner 5, and the damper hub 7. Meanwhile, when lock-up is established by the lock-up clutch 8, as seen from FIG. 1, torque (power) from the engine EG is transferred to the input shaft IS of the transmission TM via a path that includes the front cover 3, the lock-up clutch 8, the drive member 11, the first springs SP1, the intermediate member 12, the second springs SP2, the driven member 15, and the damper hub 7.

When the drive member 11 which is coupled to the front cover 3 by the lock-up clutch 8 is rotated along with rotation of the engine EG while lock-up is established by the lock-up clutch 8, the first and second springs SP1 and SP2 act in series with each other via the intermediate member 12 between the drive member 11 and the driven member 15 until torque transferred to the drive member 11 reaches the torque T1. Consequently, torque from the engine EG transferred to the front cover 3 is transferred to the input shaft IS of the transmission TM, and fluctuations in torque from the engine EG are damped (absorbed) by the first and second springs SP1 and SP2 of the damper device 10. When torque transferred to the drive member 11 becomes equal to or more than the torque T1, meanwhile, fluctuations in torque from the engine EG are damped (absorbed) by the first springs SP1 of the damper device 10 until the torque reaches the torque T2.

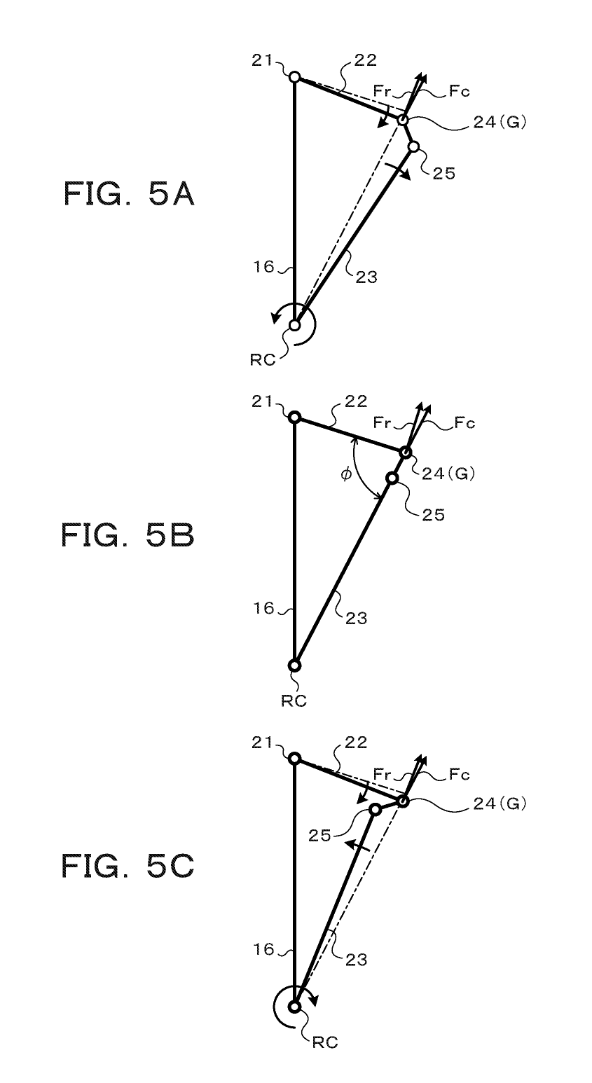

In the starting device 1, further, when the damper device 10, which is coupled to the front cover 3 by the lock-up clutch 8 along with establishment of lock-up, is rotated together with the front cover 3, the first driven plate 16 (driven member 15) of the damper device 10 is also rotated in the same direction as the front cover 3 about the axis of the starting device 1. Along with rotation of the first driven plate 16, the crank members 22 and the inertial mass body 23 which constitute the vibration damping device 20 are swung with respect to the first driven plate 16 as illustrated in FIGS. 5A, 5B, and 5C. Consequently, it is possible to damp vibration of the first driven plate 16 by applying vibration that is opposite in phase to vibration transferred from the engine EG to the drive member 11 from the inertial mass body 23 which is swung to the first driven plate 16 via the second coupling shafts 24 and the crank members 22. That is, the vibration damping device 20 is configured to have an order that matches the order (excitation order: 1.5th order in the case where the engine EG is e.g. a three-cylinder engine, and second order in the case where the engine EG is e.g. a four-cylinder engine) of vibration transferred from the engine EG to the first driven plate 16, and damps vibration transferred from the engine EG to the first driven plate 16 irrespective of the rotational speed of the engine EG (first driven plate 16). Consequently, it is possible to damp vibration significantly well using both the damper device 10 and the vibration damping device 20 while suppressing an increase in weight of the damper device 10.

In the vibration damping device 20, a four-node rotary link mechanism can be constituted without using a link coupled to both the crank members 22 and the inertial mass body 23, that is, a connecting rod in a common four-node rotary link mechanism. Thus, in the vibration damping device 20, it is not necessary to secure the strength or the durability of the connecting rod by increasing the thickness or the weight, and thus it is possible to suppress an increase in weight or size of the entire device well. In the vibration damping device 20 which does not include a connecting rod, additionally, the vibration damping performance can be secured well by suppressing a reduction in restoring force that acts on the crank member 22 that is attributable to movement of the center of gravity G of the crank member 22 toward the center of rotation RC due to an increase in weight (moment of inertia) of the connecting rod.

Meanwhile, it is not necessary to provide a bearing such as a sliding bearing or a rolling bearing on the virtual axis 25 of the vibration damping device 20, and thus it is possible to easily shorten the interaxial distance L3 between the second coupling shaft 24 and the virtual axis 25 by improving the degree of freedom in setting of the interaxial distance L3, that is, the length of the connecting rod in the common four-node rotary link mechanism. Thus, the vibration damping performance of the vibration damping device 20 can be improved easily by adjusting the interaxial distance L3. Further, a link (connecting rod) coupled to both the crank member 22 and the inertial mass body 23 is not required, and thus a component force of a centrifugal force Fc that acts on the crank member 22 is not used to return the link which is coupled to both the crank member 22 and the inertial mass body 23 to the position in the equilibrium state. Thus, the vibration damping performance of the vibration damping device 20 can be improved while an increase in weight of the crank member 22 is suppressed. As a result, with the vibration damping device 20, it is possible to further improve the vibration damping performance while suppressing an increase in weight or size of the entire device.

Next, the procedure for designing the vibration damping device 20 will be described.

A device obtained by omitting a connecting rod and an inertial mass body from the vibration damping device 20 discussed above is considered to correspond to a centrifugal-pendulum vibration absorbing device. In the centrifugal-pendulum vibration absorbing device, the vibration angle of a pendulum mass body becomes larger along with an increase in amplitude of vibration of input torque transferred to a support member for the pendulum mass body, and a restoring force that acts to return the pendulum mass body to an equilibrium state (balanced position) becomes smaller as the vibration angle becomes larger. Therefore, when the amount of decrease in the restoring force, that is, the equivalent rigidity of the centrifugal-pendulum vibration absorbing device, with respect to the amount of variation in the moment of inertia of the pendulum mass body, that is, the equivalent mass of the centrifugal-pendulum vibration absorbing device, becomes larger, the effective order, which is the order of vibration that may be best damped by the centrifugal-pendulum vibration absorbing device, becomes lower as the vibration angle of the pendulum mass body becomes larger. The vibration damping performance of the centrifugal-pendulum vibration absorbing device is degraded as the amount of decrease in effective order (difference from the excitation order) becomes larger. Thus, the centrifugal-pendulum vibration absorbing device is generally designed such that the amount of decrease in effective order when the vibration angle becomes larger is as small as possible.

In the vibration damping device 20 discussed above, in contrast, when an amplitude λ of vibration of torque (hereinafter referred to as “input torque”) transferred from the drive member 11 to the driven member 15 becomes larger and the vibration angle of the inertial mass body 23 becomes larger, a deviation is caused between the order of vibration that should originally be damped by the vibration damping device 20, that is, an excitation order q_{tag} of the engine EG, and an effective order q_{eff} which is the order of vibration best damped by the vibration damping device 20. That is, with the vibration damping device 20, the effective order q_{eff} may become lower or higher than the excitation order q_{tag} of the engine EG, depending on the specifications of the vibration damping device, as the vibration angle of the inertial mass body 23, that is, the amplitude λ of vibration of the input torque, becomes larger.

Thus, the inventors first made a simulation to search for a combination of the interaxial distances L2, L3, and L4 and the length Lg (length from the center of the first coupling shaft 21 to the center of gravity G of the crank member 22) that did not vary the effective order q_{eff} even if the amplitude λ of vibration of the input torque was varied with a mass M of the crank member 22, a moment of inertia J of the inertial mass body 23, the number of cylinders n of the engine EG, the interaxial distance L1 which depends on the requirement for mounting of the vibration damping device 20, and so forth kept constant. In the simulation, when a state in which the inertial mass body 23 had been rotated by a certain initial angle (an angle corresponding to the vibration angle of the inertial mass body 23 about the center of rotation RC) about the center of rotation RC from the position in the equilibrium state was defined as an initial state in a plurality of models of the vibration damping device 20 with different interaxial distances L2, L3, and L4 and length Lg, torque that did not contain a vibration component was applied to the first driven plate 16 for each of a plurality of initial angles to rotate the first driven plate 16 at a constant rotational speed (e.g. 1000 rpm) to swing the inertial mass body 23 etc. at a frequency that matched the initial angle. The plurality of models used in the simulation had each been prepared to damp vibration with an excitation order q_{tag}=1.5 from three-cylinder engines. In the simulation, the effects of a centrifugal hydraulic pressure that acted on the crank member 22 etc. in the fluid transmission chamber 9 and friction between the members were ignored.

As a result of the simulation, it was revealed that the effective order q_{eff} was kept generally constant even if the amplitude λ of vibration of the input torque was varied in the case where the relationship of the following formula (1) was established in the vibration damping device 20. In the formula (1) (and the formulae (2) and (3)), “α”, “β”, and “γ” are each a constant determined through simulation, and meet 0.02≤α≤0.15, 0.04≤β≤0.06, and 0.6≤γ≤0.75, for example. As a result of the analysis conducted by the inventors, in addition, it was also revealed that the effective order q_{eff} became higher as the amplitude λ of vibration of the input torque became larger in the case where the relationship of the following formula (2) was established in the vibration damping device 20, and that the effective order q_{eff} became lower as the amplitude λ of vibration of the input torque became larger in the case where the relationship of the following formula (3) was established in the vibration damping device 20. As a result of the analysis, further, it was revealed that a convergence value (hereinafter referred to as a “reference order q_{ref}”) of the effective order q_{eff} when the amplitude λ of vibration of the input torque became smaller was varied by varying the mass M of the crank member 22 and the moment of inertia J of the inertial mass body 23 in the vibration damping device 20 which met any of the formulae (1), (2), and (3). In this case, the reference order q_{ref} is higher as the mass M of the crank member 22 is smaller, and is higher as the moment of inertia J of the inertial mass body 23 is larger.

L4/(L3+L4)=α·(Lg/L2)+β·n+γ (1)

L4/(L3+L4)>α·(Lg/L2)+β·n+γ (2)

L4/(L3+L4)<α·(Lg/L2)+β·n+γ (3)

Further, the inventors examined the relationship between the amount of deviation of the effective order q_{eff} which matches the amplitude λ of vibration of the input torque and the vibration damping performance of the vibration damping device 20 on the basis of the results of the simulation and the analysis discussed above. Here, the relationship between a rotational speed Ne of the engine EG (which is a four-cylinder engine) and torque fluctuations T_{Fluc} of the driven member 15 was evaluated for a plurality of models of the vibration damping device 20, for which the interaxial distances L2, L3, and L4, the length Lg, the mass M, and the moment of inertia J were determined such that proportions ρ of the amount of deviation of the effective order q_{eff} from the excitation order q_{tag} with respect to the excitation order q_{tag} were different from each other and such that the reference order q_{ref} coincided with the excitation order q_{tag} of the engine EG, using the above formulae (1) to (3). The amount of deviation of the effective order q_{eff} from the excitation order q_{tag} is obtained by subtracting the excitation order q_{tag} from the effective order q_{eff} when the amplitude λ of vibration of the input torque is maximum and the vibration angle of the inertial mass body 23 is maximum.

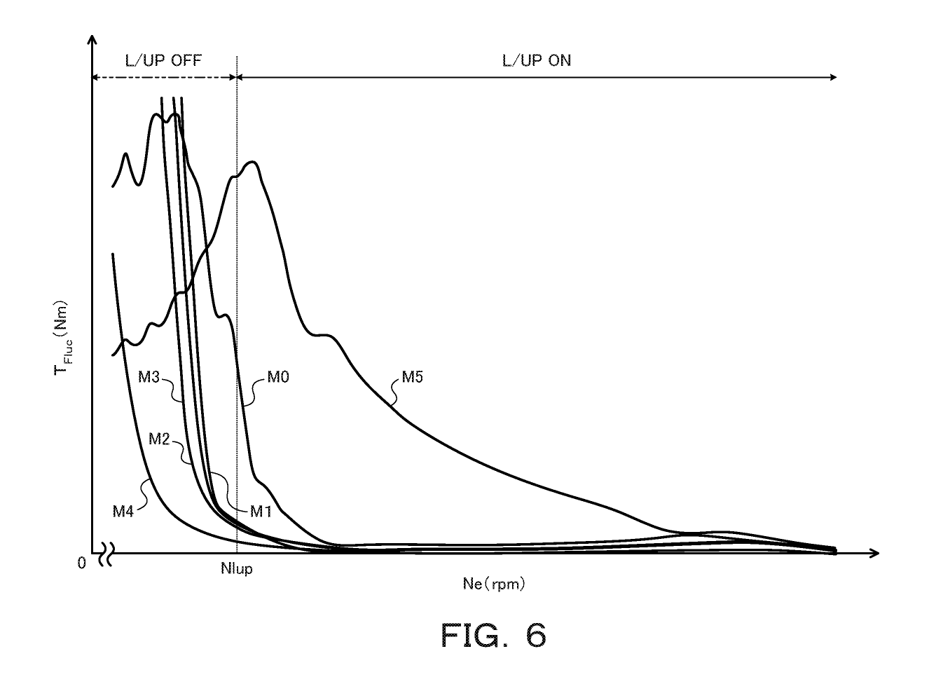

FIG. 6 illustrates the relationship between the rotational speed Ne and the torque fluctuations T_{Fluc} of the driven member 15 in a plurality of models M0, M1, M2, M3, M4, and M5 with the reference order q_{ref} adjusted by keeping the mass M of the crank member 22 constant and varying the moment of inertia J of the inertial mass body 23. The drawing illustrates the results of analyzing the torque fluctuations T_{Fluc} (vibration level) of the driven member 15 in a state in which torque is transferred from the engine EG to the driven member 15 through execution of lock-up.

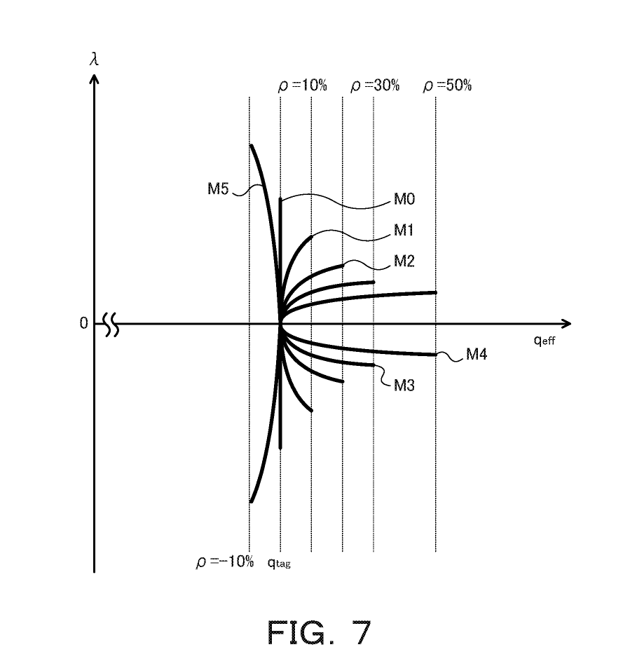

The model M0 in FIG. 6 is a model of the vibration damping device 20 prepared such that the proportion ρ of the amount of deviation of the effective order q_{eff} from the excitation order q_{tag} with respect to the excitation order q_{tag} is 0%, that is, the effective order q_{eff} is not varied even if the amplitude λ of vibration of the input torque is varied, as illustrated in FIG. 7. The model M1 in FIG. 6 is a model of the vibration damping device 20 prepared such that the proportion ρ is 10% as illustrated in FIG. 7. The moment of inertia J of the inertial mass body 23 in the model M1 is about 1.5 times the moment of inertia J of the inertial mass body 23 in the model M0. The model M2 in FIG. 6 is a model of the vibration damping device 20 prepared such that the proportion ρ is 20% as illustrated in FIG. 7. The moment of inertia J of the inertial mass body 23 in the model M2 is about twice the moment of inertia J of the inertial mass body 23 in the model M0. The model M3 in FIG. 6 is a model of the vibration damping device 20 prepared such that the proportion ρ is 30% as illustrated in FIG. 7. The moment of inertia J of the inertial mass body 23 in the model M3 is about 2.5 times the moment of inertia J of the inertial mass body 23 in the model M0. The model M4 in FIG. 6 is a model of the vibration damping device 20 prepared such that the proportion ρ is 50% as illustrated in FIG. 7. The moment of inertia J of the inertial mass body 23 in the model M4 is about seven times the moment of inertia J of the inertial mass body 23 in the model M0. The model M5 in FIG. 6 is a model of the vibration damping device 20 prepared such that the proportion ρ is −10% (the effective order q_{eff} becomes lower as the amplitude λ of vibration of the input torque becomes larger) as illustrated in FIG. 7. The moment of inertia J of the inertial mass body 23 in the model M5 is about 0.5 times the moment of inertia J of the inertial mass body 23 in the model M0.

For the model M5, the effective order q_{eff} of which becomes lower as the amplitude λ of vibration of the input torque becomes larger, as seen from FIG. 6, the torque fluctuations T_{Fluc} of the driven member 15 around a lock-up rotational speed Nlup (e.g. 1000 rpm) of the lock-up clutch 8 are significantly large, and the torque fluctuations T_{Fluc} of the driven member 15 in a region of a lock-up region in which the rotational speed Ne is relatively low are also relatively large. For the models M1 to M4, the effective order q_{eff} of which becomes higher as the amplitude λ of vibration of the input torque becomes larger, in contrast, the torque fluctuations T_{Fluc} of the driven member 15 around the lock-up rotational speed Nlup are sufficiently small to be less than those for the model M0, for which the proportion ρ is 0%, and the torque fluctuations T_{Fluc} of the driven member 15 in a region of the lock-up region in which the rotational speed Ne is relatively low are also sufficiently small. For the models M1 to M4, further, the torque fluctuations T_{Fluc} of the driven member 15 around the lock-up rotational speed Nlup are smaller as the moment of inertia J of the inertial mass body 23 is larger.

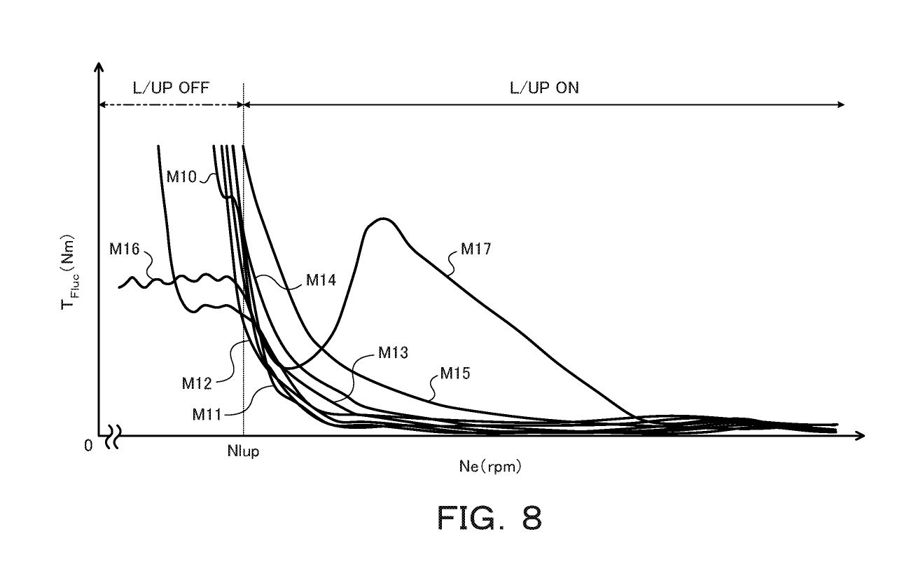

FIG. 8 illustrates the relationship between the rotational speed Ne and the torque fluctuations T_{Fluc} of the driven member 15 in a plurality of models M10, M11, M12, M13, M14, M15, M16, and M17 with the reference order q_{ref} adjusted by keeping the moment of inertia J of the inertial mass body 23 constant and varying the mass M of the crank member 22. The drawing also illustrates the results of analyzing the torque fluctuations T_{Fluc} of the driven member 15 in a state in which torque is transferred from the engine EG to the driven member 15 through execution of lock-up.

The model M10 in FIG. 8 is a model of the vibration damping device 20 prepared such that the proportion ρ of the amount of deviation of the effective order q_{eff} from the excitation order q_{tag} with respect to the excitation order q_{tag} is 0%, that is, the effective order q_{eff} is not varied even if the amplitude λ of vibration of the input torque is varied. The model M 11 in FIG. 8 is a model of the vibration damping device 20 prepared such that the proportion ρ is 10%. The mass M of the crank member 22 in the model M11 is about 0.65 times the mass M of crank member 22 in the model M10. The model M12 in FIG. 8 is a model of the vibration damping device 20 prepared such that the proportion ρ is 18%. The mass M of the crank member 22 in the model M12 is about 0.6 times the mass M of crank member 22 in the model M10. The model M13 in FIG. 8 is a model of the vibration damping device 20 prepared such that the proportion ρ is 20%. The mass M of the crank member 22 in the model M13 is about 0.5 times the mass M of crank member 22 in the model M10. The model M14 in FIG. 8 is a model of the vibration damping device 20 prepared such that the proportion ρ is 30%. The mass M of the crank member 22 in the model M14 is about 0.4 times the mass M of crank member 22 in the model M10. The model M15 in FIG. 8 is a model of the vibration damping device 20 prepared such that the proportion ρ is 50%. The mass M of the crank member 22 in the model M15 is about 0.15 times the mass M of crank member 22 in the model M10. The model M16 in FIG. 8 is a model of the vibration damping device 20 prepared such that the proportion ρ is −8%. The mass M of the crank member 22 in the model M16 is about 1.2 times the mass M of crank member 22 in the model M10. The model M17 in FIG. 8 is a model of the vibration damping device 20 prepared such that the proportion ρ is −10%. The mass M of the crank member 22 in the model M17 is about twice the mass M of crank member 22 in the model M10.

For the model M17, the effective order q_{eff} of which becomes lower as the amplitude λ of vibration of the input torque becomes larger, as seen from FIG. 8, the torque fluctuations T_{Fluc} of the driven member 15 around the lock-up rotational speed Nlup of the lock-up clutch 8 are significantly large, and the torque fluctuations T_{Fluc} of the driven member 15 in a region of the lock-up region in which the rotational speed Ne is relatively low are also relatively large. For the model M16, for which the proportion ρ is −8%, the model M10, for which the proportion ρ is 0%, the model M11, for which the proportion ρ is 10%, the model M12, for which the proportion ρ is 18%, and the model M13, for which the proportion ρ is 20%, in contrast, the torque fluctuations T_{Fluc} of the driven member 15 around the lock-up rotational speed Nlup are sufficiently small, and the torque fluctuations T_{Fluc} of the driven member 15 in a region of the lock-up region in which the rotational speed Ne is relatively low are also sufficiently small. For the models M13, M14, and M15, for which the proportion ρ is 20% to 50%, in addition, the torque fluctuations T_{Fluc} of the driven member 15 around the lock-up rotational speed Nlup are larger as the mass M of the crank member 22 is smaller.

In the light of the analysis results illustrated in FIGS. 6 and 8, the vibration damping device 20 according to the present embodiment is designed such that the effective order q_{eff} becomes higher as the amplitude λ of vibration of the input torque transferred from the engine EG to the driven member 15 becomes larger on the basis of the above formula (2). In the case where the effective order q_{eff} becomes higher as the amplitude λ of vibration of the input torque becomes larger in this way, the effective order q_{eff} becomes lower as the amplitude λ becomes smaller. In addition, the fact that the effective order q_{eff} is low when the amplitude λ of vibration of the input torque is small means that an equivalent mass M_{eq} of the vibration damping device 20 when the amplitude λ is small (in a stationary state) is large, or that an equivalent rigidity K_{eq} of the vibration damping device 20 is low.

That is, in the vibration damping device 20, the effective order q_{eff} of which becomes higher as the amplitude λ becomes larger, the moment of inertia J of the inertial mass body 23 can be caused to become relatively larger by increasing the moment of inertia J of the inertial mass body 23 so as to increase the equivalent mass M_{eq} (see FIG. 6), or by reducing the mass M (a restoring force that acts on the restoring force generation member) of the crank member 22 so as to reduce the equivalent rigidity K_{eq} (see FIG. 8). From the analysis results illustrated in FIGS. 6 and 8, it is understood that the degree of improvement in vibration damping performance due to such an increase in moment of inertia J of the inertial mass body 23 is sufficiently large compared to the degree of reduction in vibration damping performance due to a deviation of the effective order q_{eff}. Thus, it is possible to further improve the vibration damping performance of the vibration damping device 20, which includes the crank members 22 and the inertial mass body 23 which is swung in conjunction with the crank members 22, by causing the effective order q_{eff} to become higher as the amplitude λ of vibration of the input torque becomes larger.

In the vibration damping device 20 according to the present embodiment, in addition, the amount of deviation described above, that is, the difference between the effective order q_{eff} when the amplitude λ of vibration of the input torque is maximum, and the excitation order q_{tag} of the engine is less than 50% (e.g. less than 20%) of the excitation order q_{tag}. That is, for the model M4 which is used in the simulation associated with FIG. 6 and for which the proportion ρ is 50%, the moment of inertia J of the inertial mass body 23 is about seven times the moment of inertia J of the inertial mass body 23 for the model M0, and thus the inertial mass body 23 and hence the vibration damping device 20 may be increased in size. Further, for the model M15 which is used in the simulation associated with FIG. 8 and for which the proportion ρ is 50%, the moment of inertia J of the inertial mass body 23 is about 0.15 times the mass M of the crank member 22 for the model M10, and thus the durability of the crank member 22 and hence the vibration damping device 20 may be lowered. Thus, by designing the vibration damping device 20 such that the proportion ρ is less than 50%, it is possible to improve the vibration damping performance while suppressing an increase in size of the vibration damping device 20 that accompanies an increase in moment of inertia J of the inertial mass body 23 and a reduction in durability that accompanies a reduction in weight of the crank member 22. As seen from FIGS. 6 and 8, the vibration damping device 20 is preferably designed such that the proportion ρ is 20% or less in order to further improve the vibration damping performance.

It should be noted, however, that the vibration damping device 20 may be designed such that the above proportion is 0%, that is, the effective order q_{eff} is not varied even if the amplitude λ of vibration of the input torque transferred from the engine EG to the driven member 15 is varied, on the basis of the above formula (1). Consequently, as seen from the analysis results illustrated in FIGS. 6 and 8, a reduction in vibration damping performance due to a deviation of the effective order q_{eff} can be suppressed well while an increase in moment of inertia J of the inertial mass body 23 and a reduction in durability that accompanies a reduction in weight of the crank member 22 are suppressed. As a result, it is possible to improve the vibration damping performance while reducing the size of the vibration damping device 20 and improving the durability thereof.

In the vibration damping device 20, in addition, the reference order q_{ref} does not necessarily need to coincide with the excitation order q_{tag}, and the vibration damping device 20 may be designed such that the reference order q_{ref} is higher than the excitation order q_{tag}. That is, the studies conducted by the inventors revealed that the vibration damping performance of the vibration damping device 20 discussed above could be further improved by making the reference order q_{ref} higher than the excitation order q_{tag} of the engine EG, rather than by causing the reference order q_{ref} to coincide with the excitation order q_{tag}. In this case, the vibration damping device 20 is preferably designed so as to meet 1.00×q_{tag}<q_{ref}≤1.03×q_{tag}, more preferably 1.01×q_{tag}≤q_{ref}≤1.02×q_{tag}. It should be noted, however, that the vibration damping device 20 may be designed such that the reference order q_{ref} is slightly lower than the excitation order q_{tag}.

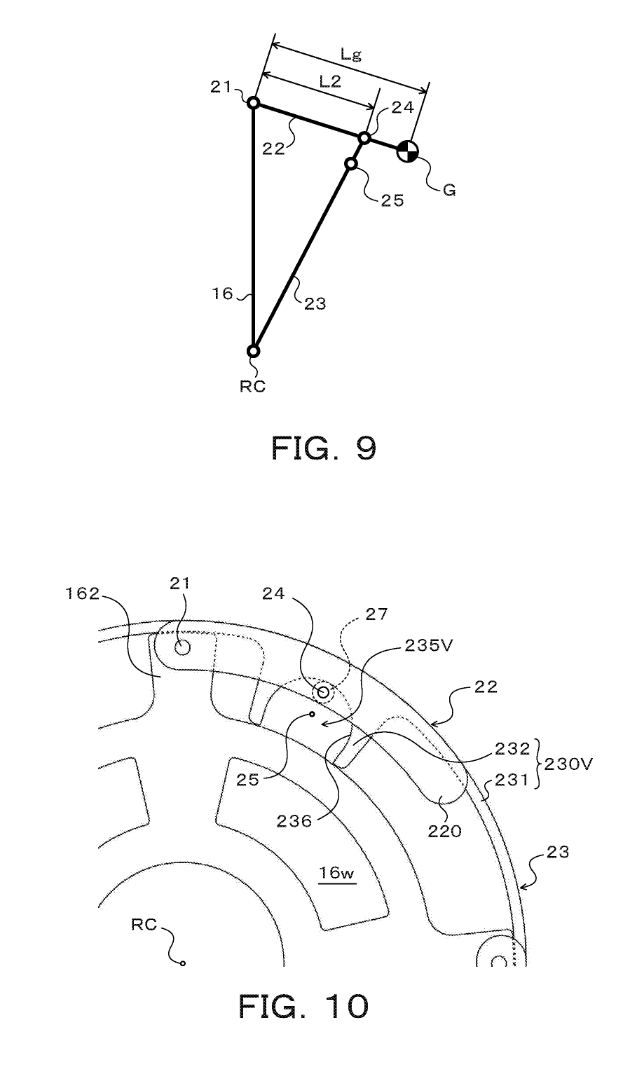

The vibration damping device 20 may be configured so as to meet the relationship Lg>L2 as illustrated in FIG. 9. Consequently, although the load which acts on the support portion (bearing portion) of the first coupling shaft 21 is increased compared to a case where the relationship Lg=L2 is met, it is possible to further increase the restoring force Fr which acts on the crank member 22 using leverage. In this case, the center of gravity G does not necessarily need to be positioned on a line that passes through the centers of the first and second coupling shafts 21 and 24.

In addition, the guide portions 235 may be formed in the crank members 22, and the second coupling shafts 24 may be supported by the inertial mass body 23. Further, the guide portion 235 includes the support surface 237 in a projecting curved surface shape which faces the guide surface 236 and the stopper surfaces 238. As illustrated in FIG. 10, however, the support surface 237 and the stopper surfaces 238 may be omitted. A guide portion 235V formed in the projecting portion 232 of an annular member 230V illustrated in FIG. 10 is a generally semi-circular notch that has the guide surface 236 in a recessed curved surface shape (recessed circular columnar surface shape) that has a constant radius of curvature. Consequently, it is possible to simplify the structure of the guide portion 235V which guides the second coupling shaft 24, and hence the structure of the vibration damping device 20. In addition, a guide portion that is similar to the guide portion 235V may be formed in the plate members 220 of the crank member 22. Additionally, the guide surface 236 may be a recessed curved surface formed such that the radius of curvature is varied stepwise or gradually, for example, as long as the second coupling shaft 24 is moved as discussed above.

Further, the annular inertial mass body 23 may be configured to be rotatably supported (aligned) by the first driven plate 16. Consequently, it is possible to smoothly swing the inertial mass body 23 about the center of rotation RC of the first driven plate 16 when the crank members 22 are swung.

In the vibration damping device 20, in addition, the inertial mass body 23 which is annular may be replaced with a plurality of (e.g. four) mass bodies that have the same specifications (such as dimensions and weight) as each other. In this case, the mass bodies may be constituted from metal plates that have an arcuate planar shape, for example, and that are coupled to the first driven plate 16 via the crank member 22 (two plate members 220), the second coupling shaft 24, and the guide portion 235 so as to be arranged at intervals (equal intervals) in the circumferential direction in the equilibrium state and swing about the center of rotation RC. In this case, guide portions that guide the mass bodies so as to swing about the center of rotation RC while receiving a centrifugal force (centrifugal hydraulic pressure) that acts on the mass bodies may be provided in the outer peripheral portion of the first driven plate 16.

Further, the vibration damping device 20 may include a dedicated support member (first link) that constitutes a turning pair with the crank member 22 by swingably supporting the crank member 22 and that constitutes a turning pair with the inertial mass body 23. That is, the crank member 22 may be coupled to a rotary element indirectly via a dedicated support member that serves as the first link. In this case, it is only necessary that the support member of the vibration damping device 20 should be coupled so as to rotate coaxially and together with a rotary element, such as the drive member 11, the intermediate member 12, or the first driven plate 16 of the damper device 10, for example, vibration of which is to be damped. Also with the thus configured vibration damping device 20, it is possible to damp vibration of the rotary element well.

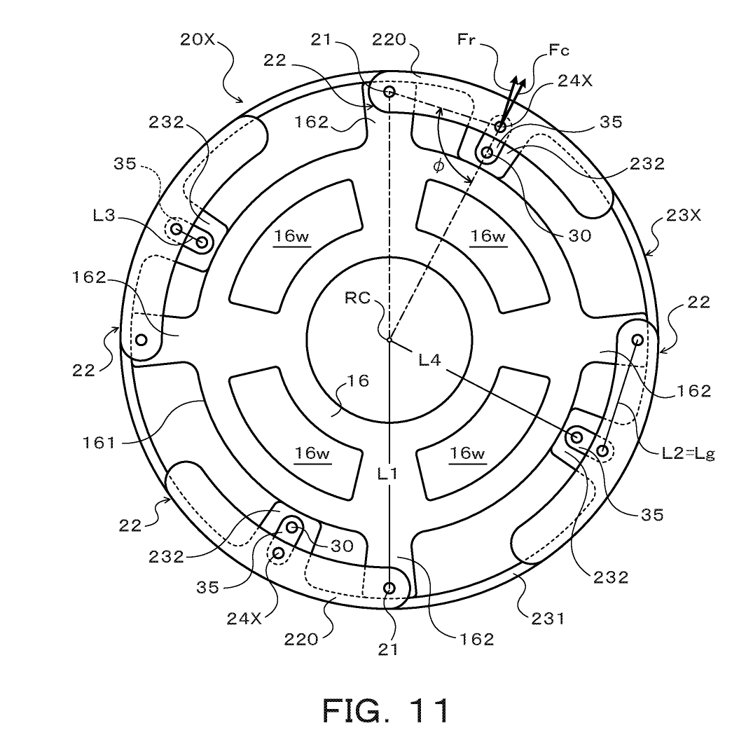

As in a vibration damping device 20X illustrated in FIG. 11, in addition, the guide portions 235 in the vibration damping device 20 may be omitted, and connecting rods 35 illustrated in the drawing may be used instead. The connecting rods 35 are each rotatably coupled to the crank member 22 via a second coupling shaft 24X, and rotatably coupled to the projecting portion 232 of an inertial mass body 23X via a third coupling shaft 30. Such a vibration damping device 20X is also designed on the basis of the above formula (1) or (2) to achieve functions and effects that are similar to those of the vibration damping device 20.

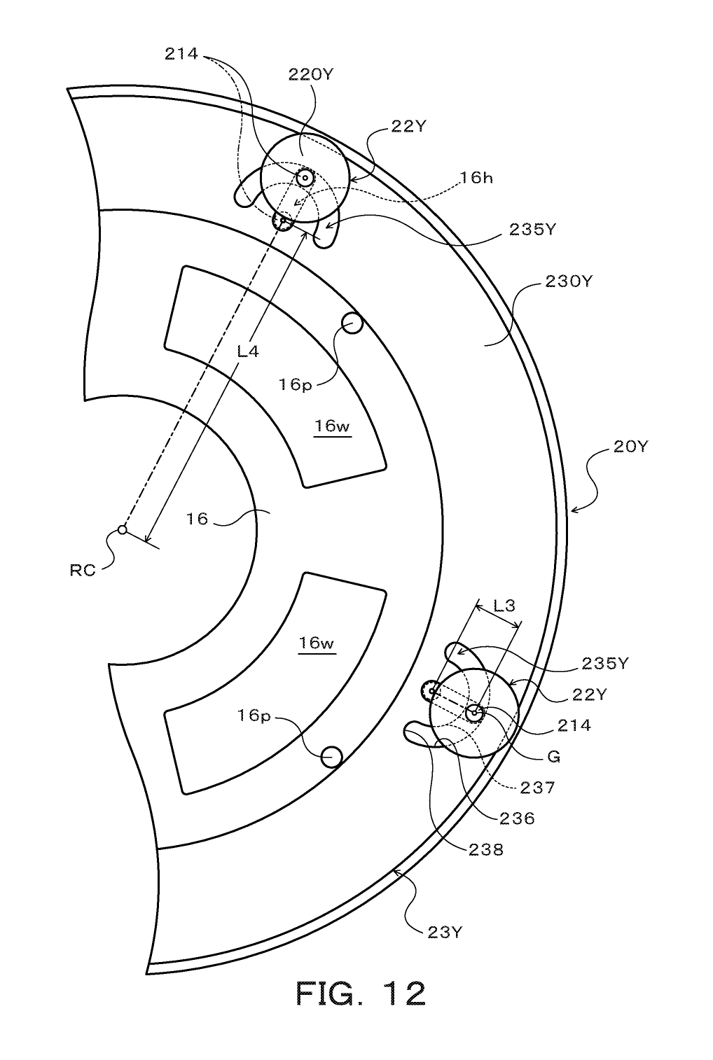

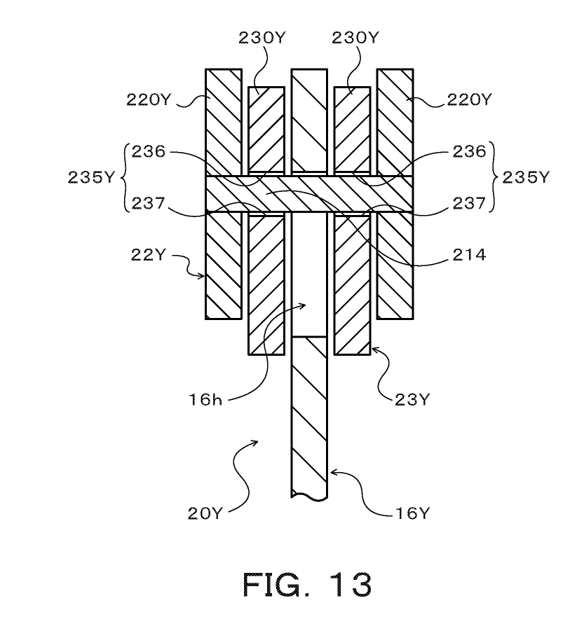

FIG. 12 is an enlarged view illustrating another vibration damping device 20Y according to the present disclosure. FIG. 13 is an enlarged sectional view illustrating an essential portion of the vibration damping device 20Y. The vibration damping device 20Y illustrated in the drawings includes: a driven plate 16Y that serves as a support member configured in the same manner as the first driven plate 16; a plurality of (e.g. four in the present embodiment) weight bodies 22Y that serve as a restoring force generation member rotatably coupled to the first driven plate 16Y via respective coupling shafts 214; and a single annular inertial mass body 23Y coupled to the driven plate 16Y and the weight bodies 22Y via the coupling shafts 214.

As illustrated in FIGS. 12 and 13, the driven plate 16Y has a plurality of (e.g. four at intervals of 90° in the present embodiment) long holes (through holes) 16h (first guide portion) disposed in the outer peripheral portion of the driven plate 16Y at intervals (equal intervals) in the circumferential direction. As illustrated in the drawings, the long holes 16h each guide the coupling shaft 214, that is, the weight body 22Y, which is formed in a solid (or hollow) round bar shape, and are each formed in the driven plate 16Y such that the center axis which extends in the longitudinal direction extends in the radial direction of the driven plate 16Y to pass through the center of rotation RC. The width (the inner dimension in a direction that is orthogonal to the longitudinal direction) of the long hole 16h is determined to be slightly larger than the outside diameter of the coupling shaft 214. As illustrated in FIG. 13, the weight bodies 22Y each have two plate members 220Y coupled to each other via the coupling shaft 214. In the present embodiment, the plate members 220Y are each formed in a disc shape from a metal plate. Further, the coupling shaft 214 is fixed (coupled) to the two plate members 220Y such that the axis of the coupling shaft 214 passes through the center of gravity G of the weight body 22Y.

The inertial mass body 23Y includes two annular members 230Y formed from a metal plate. The weight of the inertial mass body 23Y (two annular members 230Y) is determined to be sufficiently larger than the weight of one weight body 22Y. As illustrated in FIGS. 12 and 13, the annular members 230Y each have a plurality of (e.g. four at intervals of 90° in the present embodiment) guide portions 235Y (second guide portion) disposed at intervals (equal intervals) in the circumferential direction. The guide portions 235Y are each an opening portion that extends arcuately, and each guide the coupling shaft 214, that is, the weight body 22Y.

As illustrated in the drawings, the guide portions 235Y each include: a guide surface 236 in a recessed curved surface shape; a support surface 237 in a projecting curved surface shape provided on the inner peripheral side of the annular member 230Y (a portion close to the center of the annular members 230Y) with respect to the guide surface 236 to face the guide surface 236; and two stopper surfaces 238 that are continuous with the guide surface 236 and the support surface 237 on both sides of the guide surface 236 and the support surface 237. In the present embodiment, the guide surface 236 is a recessed circular columnar surface that has a constant radius of curvature. The support surface 237 is a projecting curved surface that extends arcuately. The stopper surfaces 238 are each a recessed curved surface that extends arcuately. In addition, the clearance between the guide surface 236 and the support surface 237 is determined to be slightly larger than the outside diameter of the coupling shaft 214. As illustrated in FIG. 12, the guide portion 235Y (the guide surface 236, the support surface 237, and the stopper surfaces 238) are formed to be transversely symmetrical with respect to a line that passes through the center of curvature of the guide surface 236 and the center of the annular members 230Y (the center of rotation RC of the driven plate 16Y).

As illustrated in FIG. 13, the two annular members 230Y are disposed coaxially with the driven plate 16Y on both sides in the axial direction of the driven plate 16Y, with one annular member 230Y on each side, such that the guide portions 235Y corresponding to each other face each other in the axial direction of the annular members 230Y. Further, the inner peripheral surfaces of the two annular members 230Y are supported by a plurality of protrusions 16p (see FIG. 12) provided on the driven plate 16Y and projecting in the axial direction, and thereby the annular members 230Y (inertial mass body 23Y) are supported by the driven plate 16Y so as to be rotatable about the center of rotation RC.

In addition, the two plate members 220Y are disposed so as to face each other in the axial direction via the corresponding driven plate 16Y and two annular members 230Y, and are coupled to each other by the coupling shaft 214. As illustrated in FIG. 13, the coupling shaft 214 which couples the two plate members 220Y to each other penetrates the associated long hole 16h of the driven plate 16Y and the associated guide portions 235Y of the two annular members 230Y. Consequently, the driven plate 16Y, the weight bodies 22Y, and the inertial mass body 23Y are coupled to each other via the coupling shafts 214, and the coupling shafts 214 are each movable along both the associated long hole 16h of the driven plate 16Y and the associated guide portions 235Y of the inertial mass body 23Y.

In the vibration damping device 20Y discussed above, the weight bodies 22Y (coupling shaft 214) constitute a sliding pair with the driven plate 16Y and the inertial mass body 23Y, and the driven plate 16Y and the inertial mass body 23Y constitute a turning pair. Consequently, the driven plate 16Y which has the long holes 16h, the plurality of weight bodies 22Y, and the inertial mass body 23Y which has the guide portions 235Y constitute a slider crank mechanism (double slider crank chain). In addition, the vibration damping device 20Y is in the equilibrium state when the coupling shafts 214 are positioned at the center of the guide portions 235Y in the circumferential direction and positioned at end portions of the long holes 16h on the radially outer side (see FIG. 12).

When the driven plate 16Y starts rotating with the vibration damping device 20Y in the equilibrium state, each of the coupling shafts 214 which couples the two plate members 220Y to each other is pressed against the guide surfaces 236 of the guide portions 235Y of the inertial mass body 23Y by the action of a centrifugal force on the weight body 22Y to roll or slide on the guide surfaces 236 toward first end portions of the guide portions 235Y. Along with rotation of the driven plate 16Y, further, the coupling shaft 214 is moved in the radial direction of the driven plate 16Y along the long hole 16h of the driven plate 16Y toward an end portion of the long hole 16h on the radially inner side. When the coupling shaft 214 reaches the first end portions of the guide portions 235Y and an end portion of the long hole 16h on the radially inner side, in addition, a component force of the centrifugal force which acts on the weight body 22Y acts as a restoring force that acts to return the coupling shaft 214 into the equilibrium state. Consequently, the coupling shaft 214 rolls or slides toward second end portions of the guide portions 235Y on the guide surfaces 236, and are moved in the radial direction of the driven plate 16Y along the long hole 16h toward an end portion of the long hole 16h on the radially outer side.

Thus, when the driven plate 16Y is rotated, the weight body 22Y is reciprocally moved (swung) in the radial direction with respect to the driven plate 16Y in the long hole 16h, and reciprocally moved (swung) with respect to the inertial mass body 23Y along the guide portions 235Y. As a result, the inertial mass body 23Y is swung (reciprocally rotated) about the center of rotation RC of the first driven plate 16Y along with movement (swinging motion) of the weight body 22Y. Consequently, vibration that is opposite in phase to vibration transferred from the engine EG to the drive member 11 is applied from the inertial mass body 23Y which is swung to the driven plate 16Y via the guide portions 235Y and the coupling shafts 214, which makes it possible to damp vibration of the driven plate 16Y.

The vibration damping device 20Y discussed above is also designed on the basis of the above formula (1) or (2) to achieve functions and effects that are similar to those of the vibration damping devices 20 and 20X. That is, the vibration damping device 20Y which is a slider crank mechanism is preferably designed such that the effective order q_{eff} is not varied even if the amplitude of vibration of the input torque transferred from the engine EG to the driven member 15 is varied, or the effective order q_{eff} becomes higher as the amplitude λ becomes larger, on the basis of the following formula (4) or (5) which is obtained by substituting Lg/L2=1 into “Lg/L2” in the above formula (1) or (2). In this case, in the formula (4) or (5), the distance between the center of gravity G of the weight bodies 22Y and the support point for swinging motion of the weight bodies 22Y along the guide portions 235Y (second guide portion) may be defined as “L3”, and the distance between the support point for swinging motion of the weight bodies 22Y along the guide portions 235Y and the center of rotation RC may be defined as “L4” (see FIG. 12). In the present embodiment, the support point for swinging motion of the weight bodies 22Y along the guide portions 235Y coincides with the center of curvature of the guide surfaces 236 (guide portions 235Y). In addition, the constants “α”, “β”, and “γ” in the formulae (4) and (5) may be defined as 0.02≤α≤0.15, 0.04≤β≤0.06, and 0.6≤γ≤0.75, for example.

L4/(L3+L4)=α+β·n+γ (4)

L4/(L3+L4)>α+β·n+γ (5)

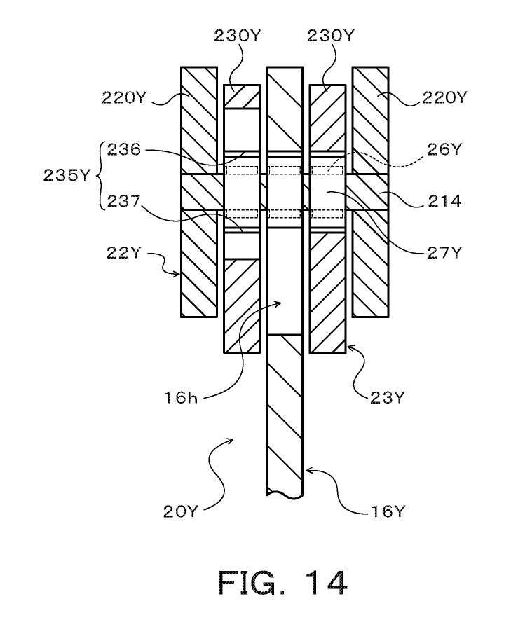

As illustrated in FIG. 14, the vibration damping device 20Y may be provided with a plurality of cylindrical outer rings 27Y rotatably supported by the coupling shaft 214 via a plurality of rollers (or balls, i.e. rolling bodies) 26Y to constitute rolling bearings. In the example illustrated in FIG. 14, three outer rings 27Y are mounted on each coupling shaft 214 so as to roll or slide on the inner surface of the long hole 16h of the driven plate 16Y and the guide portions 235Y (guide surfaces 236) of the inertial mass body 23Y (annular members 230Y). Consequently, it is possible to swing the weight bodies 22Y and the inertial mass body 23Y more smoothly.

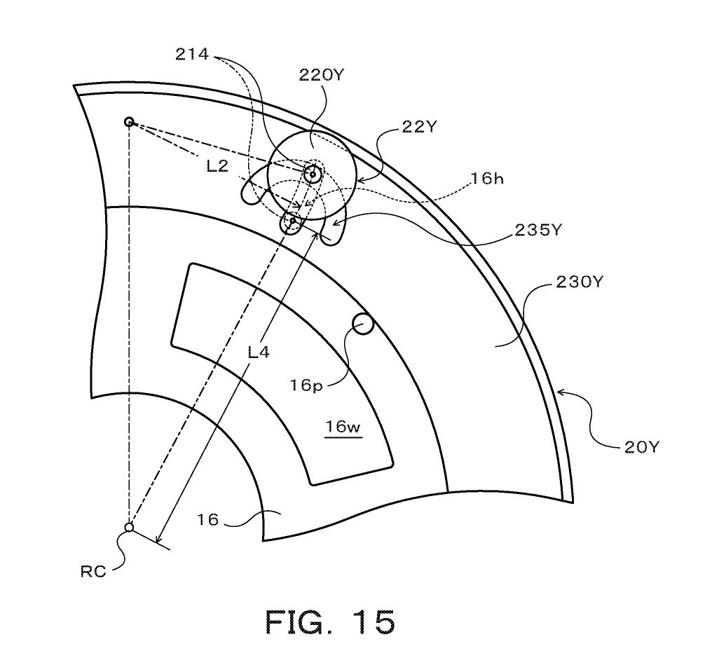

In the vibration damping device 20Y, in addition, the guide surface 236 of the guide portion 235Y is a recessed circular columnar surface that has a constant radius of curvature. However, the guide surface 236 may be a recessed curved surface formed such that the radius of curvature is varied stepwise or gradually. Further, the support surface 237 and the stopper surfaces 238 may be omitted from the guide portion 235Y. In the vibration damping device 20Y, in addition, the inertial mass body 23Y does not necessarily need to be supported so as to be rotatable about the center of rotation RC by the driven plate 16Y. Swinging motion of the inertial mass body 23Y can be made transversely symmetrical by forming the long hole 16h in the driven plate 16Y such that the center axis of the long hole 16h extends in the radial direction of the driven plate 16Y to pass through the center of rotation RC. However, the long hole 16h is not limited thereto. That is, as illustrated in FIG. 15, the long hole 16h may be formed in the driven plate 16Y such that the center axis of the long hole 16h extends arcuately. In this case, as illustrated in FIG. 15, the vibration damping device 20Y can be caused to operate in the same manner as the vibration damping device 20 by determining the center of curvature of the center axis of the long hole 16h on the center axis of the first coupling shaft 21 in the vibration damping device 20, and causing the radius of curvature of the center axis of the long hole 16h to coincide with the interaxial distance L2 between the first coupling shaft 21 and the second coupling shaft 24 in the vibration damping device 20.

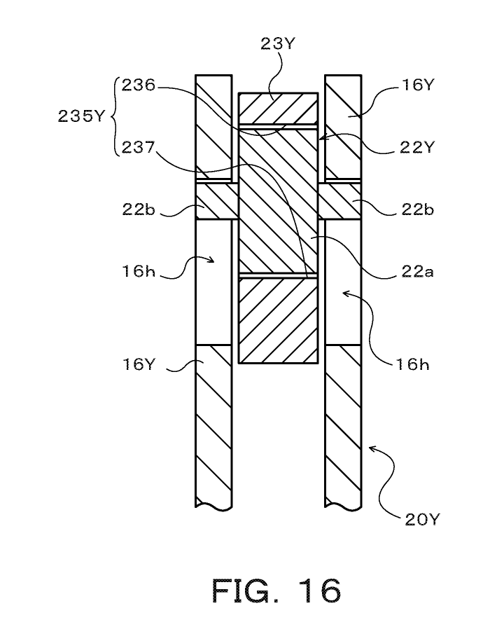

Further, as illustrated in FIG. 16, the vibration damping device 20Y which is a slider crank mechanism may include: two driven plates 16Y that serve as a support member; an inertial mass body 23Y that is a single annular member disposed between the two driven plates 16Y in the axial direction; and a plurality of weight bodies 22Y each guided by long holes 16h of the driven plates 16Y and a guide portion 235Y (guide surface 236) of the inertial mass body 23Y. In this case, as illustrated in the drawing, the weight bodies 22Y may each include a body 22a with a large diameter guided by the guide portion 235Y of the inertial mass body 23Y and shaft portions 22b that extend from the body 22a toward both sides in the axial direction so as to be guided by the long holes 16h of the respective driven plates 16Y.

In the vibration damping device 20Y, in addition, a guide portion (second guide portion) corresponding to the guide portion 235Y may be formed in the weight body 22Y, and the coupling shaft 214 may be coupled (fixed) to the inertial mass body 23Y. Further, a first guide portion corresponding to the long hole 16h may be provided in the weight body 22Y. In this case, a second guide portion corresponding to the guide portion 235Y may be provided in either the driven plates 16Y (support member) or the inertial mass body 23Y, and the coupling shaft 214 may be provided on the other of the driven plates 16Y and the inertial mass body 23Y. In addition, a first guide portion corresponding to the long hole 16h may be provided in the inertial mass body 23Y. In this case, a second guide portion corresponding to the guide portion 235Y may be provided in either the driven plates 16Y or the weight body 22Y, and the coupling shaft 214 may be provided on the other of the driven plates 16Y and the weight body 22Y.

Further, the vibration damping device 20, 20X, 20Y is a vibration damping device of a wet type disposed in the fluid transmission chamber 9 which is filled with working oil. However, the type of the vibration damping device is not limited thereto. That is, the vibration damping device 20, 20X, 20Y may be used as a vibration damping device of a so-called dry type.

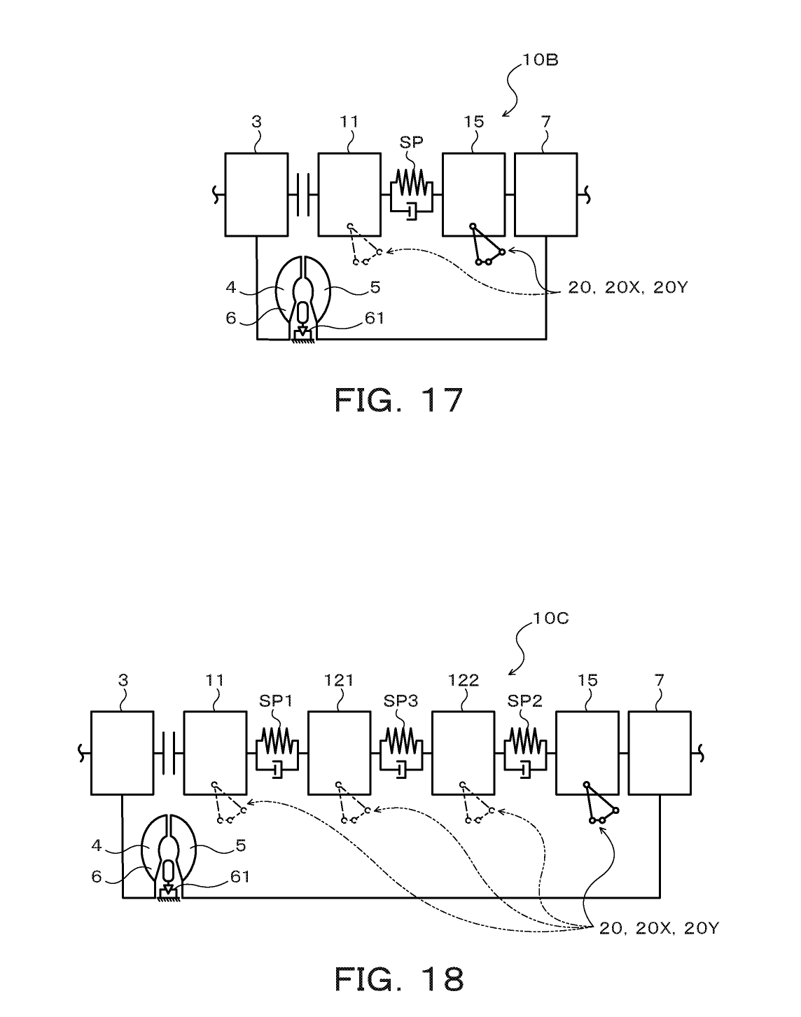

The vibration damping device 20, 20X, 20Y may be coupled to the intermediate member 12 of the damper device 10, or may be coupled to the drive member (input element) 11 (see the dash-double-dot line in FIG. 1). In addition, the vibration damping device 20, 20X, 20Y may be applied to a damper device 10B illustrated in FIG. 17. The damper device 10B of FIG. 17 corresponds to the damper device 10 from which the intermediate member 12 has been omitted, and includes the drive member (input element) 11 and the driven member 15 (output element) as rotary elements, and also includes springs SP disposed between the drive member 11 and the driven member 15 as a torque transfer element. In this case, the vibration damping device 20, 20X, 20Y may be coupled to the driven member 15 of the damper device 10B as illustrated in the drawing, or may be coupled to the drive member 11 as indicated by the dash-double-dot line in the drawing.

Further, the vibration damping device 20, 20X, 20Y may be applied to a damper device 10C illustrated in FIG. 18. The damper device 10C of FIG. 18 includes the drive member (input element) 11, a first intermediate member (first intermediate element) 121, a second intermediate member (second intermediate element) 122, and the driven member (output element) 15 as rotary elements, and also includes first springs SP1 disposed between the drive member 11 and the first intermediate member 121, second springs SP2 disposed between the second intermediate member 122 and the driven member 15, and third spring SP3 disposed between the first intermediate member 121 and the second intermediate member 122 as torque transfer elements. In this case, the vibration damping device 20, 20X, 20Y may be coupled to the driven member 15 of the damper device 10C as illustrated in the drawing, or may be coupled to the first intermediate member 121, the second intermediate member 122, or the drive member 11 as indicated by the dash-double-dot line in the drawing. In any case, by coupling the vibration damping device 20, 20X, 20Y to a rotary element of the damper device 10, 10B, or 10C, it is possible to damp vibration significantly well using both the damper device 10 to 10C and the vibration damping device 20, 20X, 20Y while suppressing an increase in weight of the damper device 10 to 10C.

As has been described above, the present disclosure provides a vibration damping device (20, 20X, 20Y) including: a support member (16, 16Y) that rotates together with a rotary element (15), to which torque from an engine (EG) is transferred, about a center of rotation (RC) of the rotary element (15); a restoring force generation member (22, 22Y) that is coupled to the support member (16, 16Y) and that is swingable along with rotation of the support member (16, 16Y); and an inertial mass body (23, 23X, 23Y) coupled to the support member (16, 16Y) via the restoring force generation member (22, 22Y) and swung about the center of rotation (RC) in conjunction with the restoring force generation member (22, 22Y) along with rotation of the support member (16, 16Y). In the vibration damping device (20, 20X, 20Y) an order (q_{eff}) of the vibration damping device becomes higher as an amplitude (λ) of vibration of input torque transferred from the engine (EG) to the rotary element (15) becomes larger.

In the case where the order of the vibration damping device becomes higher as the amplitude of vibration of the input torque becomes larger in this way, the order becomes lower as the amplitude of vibration of the input torque becomes smaller. In addition, the fact that the order of the vibration damping device is low when the amplitude of vibration of the input torque is small means that an equivalent mass of the vibration damping device when the amplitude of vibration of the input torque is small (in a stationary state) is large, or that an equivalent rigidity of the vibration damping device is low. That is, in the vibration damping device, the order of which becomes higher as the amplitude of vibration of the input torque becomes larger, the moment of inertia of the inertial mass body can be caused to become relatively larger by increasing the moment of inertia of the inertial mass body so as to increase the equivalent mass, or by reducing the mass (a restoring force that acts on the restoring force generation member) of the restoring force generation member so as to reduce the equivalent rigidity. The studies conducted by the inventors revealed that the degree of improvement in vibration damping performance due to such an increase in moment of inertia of the inertial mass body was sufficiently large compared to the degree of reduction in vibration damping performance due to a deviation of the order. Thus, it is possible to further improve the vibration damping performance of the vibration damping device, which includes the restoring force generation member and the inertial mass body which is swung in conjunction with the restoring force generation member, by causing the order of the vibration damping device to become higher as the amplitude of vibration of the input torque becomes larger.

A difference between the order (q_{eff}) of the vibration damping device when the amplitude (λ) of the vibration of the input torque is maximum and an excitation order (q_{tag}) of the engine may be less than 50% of the excitation order, and may be less than 20% of the excitation order. Consequently, it is possible to improve the vibration damping performance while suppressing an increase in size of the vibration damping device that accompanies an increase in moment of inertia of the inertial mass body and a reduction in durability that accompanies a reduction in weight of the restoring force generation member.

The vibration damping device (20Y) may further include: a first guide portion (16h) that is provided in one of the support member (16Y), the restoring force generation member (22Y), and the inertial mass body (23Y) and that extends along a radial direction of the support member (16Y); and a second guide portion (235Y) that is formed in one of two other than the one of the support member (16Y), the restoring force generation member (22Y), and the inertial mass body (23Y) and that extends arcuately, and the other of the two other than the one of the support member (16Y), the restoring force generation member (22Y), and the inertial mass body (23Y) may be guided by the first and second guide portions (16h, 235Y). With such a vibration damping device, it is possible to further improve the vibration damping performance, while suppressing an increase in weight or size of the entire device, by causing the order of the vibration damping device to become higher as the amplitude of vibration of the input torque becomes larger.

When a distance between a center of gravity of the restoring force generation member (22Y) and a support point for swinging motion of the restoring force generation member (22Y) along the second guide portion is defined as “L3”, a distance between the support point and the center of rotation (RC) is defined as “L4”, and the number of cylinders of the engine is defined as “n”, the vibration damping device (20Y) may meet L3/(L3+L4)>α+β·n+γ, where “α”, “β”, and “γ” are each a constant determined in advance. Consequently, it is possible to cause the order to become higher as the amplitude of vibration of input torque transferred from the engine to the rotary element becomes larger.

The vibration damping device (20) may further include: a first coupling shaft (21) that couples the support member (16) and the restoring force generation member (22) so as to be rotatable relative to each other; a second coupling shaft (24) that is supported by one of the restoring force generation member (22) and the inertial mass body (23) and that couples the restoring force generation member (22) and the inertial mass body (23) so as to be rotatable relative to each other; and a guide portion (235, 235V) that is formed in the other of the restoring force generation member (22) and the inertial mass body (23) and that guides the second coupling shaft (24) such that the second coupling shaft (24) is swung about the first coupling shaft (21) while keeping an interaxial distance (L2) between the first coupling shaft (21) and the second coupling shaft (24) constant, and such that the second coupling shaft (24) is swung about a virtual third coupling shaft (25), a relative position of which with respect to the inertial mass body (23) is determined to be invariable, while keeping an interaxial distance (L3) between the third coupling shaft (25) and the second coupling shaft (24) constant, along with rotation of the support member (16). Consequently, it is possible to further improve the vibration damping performance while suppressing an increase in weight or size of the entire vibration damping device.

The vibration damping device (20X) may further include a connecting member (35) rotatably coupled to the restoring force generation member (22) via a second coupling shaft (24X) and rotatably coupled to the inertial mass body (23X) via a third coupling shaft (30).

When an interaxial distance between the center of rotation (RC) of the rotary element (15) and the first coupling shaft (21) is defined as “L1”, an interaxial distance between the first coupling shaft (21) and the second coupling shaft (24, 24X) is defined as “L2”, an interaxial distance between the second coupling shaft (24, 24X) and the third coupling shaft (25, 30) is defined as “L3”, and an interaxial distance between the third coupling shaft (25, 30) and the center of rotation (RC) is defined as “L4”, the vibration damping device (20, 20X) may meet L1+L2>L3+L4. Consequently, the effect of the weight of the restoring force generation member on the equivalent mass of the vibration damping device can be made very small, which can further improve the degree of freedom in setting of the equivalent rigidity and the equivalent mass, that is, the vibration order. As a result, it is possible to improve the vibration damping performance significantly well while suppressing an increase in weight or size of the restoring force generation member and hence the entire device.

When a distance from the coupling shaft (21) to a center of gravity (G) of the restoring force generation member (22) is defined as “Lg” and the number of cylinders of the engine (EG) is defined as “n”, the vibration damping device (20, 20X) may meet L3/(L3+L4)>α·(Lg/L2)+β·n+γ, where “α”, “β”, and “γ” are each a constant determined in advance. By designing the vibration damping device so as to meet such a relational formula, it is possible to cause the order to become higher as the amplitude of vibration of input torque transferred from the engine to the rotary element becomes larger.

The vibration damping device (20, 20X, 20Y) may be set such that a reference order (q_{ref}), which is a convergent value of the order (q_{eff}) of the vibration damping device when the amplitude (λ) of the vibration of the input torque transferred to the rotary element (15) becomes smaller, is higher than an excitation order (q_{tag}) of the engine (EG). Consequently, it is possible to further improve the vibration damping performance of the vibration damping device which includes the restoring force generation member and the inertial mass body which is swung in conjunction with the restoring force generation member.

The support member (16, 16Y) may rotate coaxially and together with a rotary element of a damper device (10, 10B, 10C) that has a plurality of rotary elements (11, 12, 121, 122, 15) that include at least an input element (11) and an output element (15), and an elastic body (SP, SP1, SP2, SP3) that transfers torque between the input element (11) and the output element (15). By coupling the vibration damping device to the rotary element of the damper device in this way, it is possible to damp vibration significantly well using both the damper device and the vibration damping device while suppressing an increase in weight of the damper device.

The output element (15) of the damper device (10, 10B, 10C) may be functionally (directly or indirectly) coupled to an input shaft (IS) of a transmission (TM).

The present disclosure also provides a vibration damping device (20, 20X, 20Y) including: a support member (16, 16Y) that rotates together with a rotary element (15), to which torque from an engine (EG) is transferred, about a center of rotation (RC) of the rotary element (15); a restoring force generation member (22, 22Y) that is coupled to the support member (16, 16Y) and that is swingable along with rotation of the support member (16, 16Y); and an inertial mass body (23, 23X, 23Y) coupled to the support member (16, 16Y) via the restoring force generation member (22, 22Y) and swung about the center of rotation (RC) in conjunction with the restoring force generation member (22, 22Y) along with rotation of the support member (16, 16Y). The vibration damping device (20, 20X, 20Y) is designed such that an order (q_{eff}) of the vibration damping device is not varied even if an amplitude (λ) of vibration of input torque transferred from the engine (EG) to the rotary element (15, 16, 16Y) is varied.

In this way, by designing the vibration damping device such that the order is not varied even if the amplitude of vibration of input torque is varied, a reduction in vibration damping performance due to a deviation of the order can be suppressed well while a reduction in durability due to an increase in moment of inertia of the inertial mass body or a reduction in weight of the restoring force generation member is suppressed. As a result, it is possible to improve the vibration damping performance while reducing the size of the vibration damping device and improving the durability thereof.

The present disclosure further provides a vibration damping device (20Y) including: a support member (16Y) that rotates together with a rotary element (15), to which torque from an engine (EG) is transferred, about a center of rotation (RC) of the rotary element (15); a restoring force generation member (22Y) that is coupled to the support member (16Y) and that is swingable along with rotation of the support member (16Y); and an inertial mass body (23Y) coupled to the support member (16Y) via the restoring force generation member (22Y) and swung about the center of rotation (RC) in conjunction with the restoring force generation member (22Y) along with rotation of the support member (16Y). The vibration damping device (20Y) further includes: a first guide portion (16h) that is provided in one of the support member (16Y), the restoring force generation member (22Y), and the inertial mass body (23Y) and that extends along a radial direction of the support member (16Y); and a second guide portion (235Y) that is formed in one of two other than the one of the support member (16Y), the restoring force generation member (22Y), and the inertial mass body (23Y) and that extends arcuately. In the vibration damping device (20Y), the other of the two other than the one of the support member (16Y), the restoring force generation member (22Y), and the inertial mass body (23Y) is guided by the first and second guide portions (16h, 235Y); and when a distance between a center of gravity of the restoring force generation member (22Y) and a support point for swinging motion of the restoring force generation member (22Y) along the second guide portion is defined as “L3”, a distance between the support point and the center of rotation (RC) is defined as “L4”, and the number of cylinders of the engine is defined as “n”, L3/(L3+L4)>α+β·n+γ is met, where “α”, “β”, and “γ” are each a constant determined in advance.

The present disclosure additionally provides a vibration damping device (20) including: a support member (16) that rotates together with a rotary element (15), to which torque from an engine (EG) is transferred, about a center of rotation (RC) of the rotary element (15); a restoring force generation member (22) that is coupled to the support member (16) and that is swingable along with rotation of the support member (16); and an inertial mass body (23) coupled to the support member (16) via the restoring force generation member (22) and swung about the center of rotation (RC) in conjunction with the restoring force generation member (22) along with rotation of the support member (16). The vibration damping device (20) further includes: a first coupling shaft (21) that couples the support member (16) and the restoring force generation member (22) so as to be rotatable relative to each other; a second coupling shaft (24) that is supported by one of the restoring force generation member (22) and the inertial mass body (23) and that couples the restoring force generation member (22) and the inertial mass body (23) so as to be rotatable relative to each other; and a guide portion (235, 235V) that is formed in the other of the restoring force generation member (22) and the inertial mass body (23) and that guides the second coupling shaft (24) such that the second coupling shaft (24) is swung about the first coupling shaft (21) while keeping an interaxial distance (L2) between the first coupling shaft (21) and the second coupling shaft (24) constant, and such that the second coupling shaft (24) is swung about a virtual third coupling shaft (25), a relative position of which with respect to the inertial mass body (23) is determined to be invariable, while keeping an interaxial distance (L3) between the third coupling shaft (25) and the second coupling shaft (24) constant, along with rotation of the support member (16). In the vibration damping device (20), when an interaxial distance between the first coupling shaft (21) and the second coupling shaft (24, 24X) is defined as “L2”, an interaxial distance between the second coupling shaft (24, 24X) and the third coupling shaft (25, 30) is defined as “L3”, an interaxial distance between the third coupling shaft (25, 30) and the center of rotation (RC) is defined as “L4”, a distance from the coupling shaft (21) to a center of gravity (G) of the restoring force generation member (22) is defined as “Lg”, and the number of cylinders of the engine (EG) is defined as “n”, L3/(L3+L4)>α·(Lg/L2)+β·n+γ may be met, where “α”, “β”, and “γ” are each a constant determined in advance.

The present disclosure is not limited to the embodiment described above in any way, and it is a matter of course that the described embodiments may be modified in various ways within the extensive scope of the disclosure. Further, the mode for carrying out the embodiments described above is merely a specific form of those aspects described in the “SUMMARY” section, and does not limit the elements of these aspects described in the “SUMMARY” section.

### INDUSTRIAL APPLICABILITY

The embodiments according to the present disclosure can be utilized in the field of manufacture of vibration damping devices that damp vibration of a rotary element.

1. A vibration damping device comprising:
a support member that rotates together with a rotary element, to which torque from an engine is transferred, about a center of rotation of the rotary element;
a restoring force generation member that is coupled to the support member and that is swingable along with rotation of the support member; and
an inertial mass body coupled to the support member via the restoring force generation member and swung about the center of rotation in conjunction with the restoring force generation member along with rotation of the support member, wherein
an order of the vibration damping device becomes higher as an amplitude of vibration of input torque transferred from the engine to the rotary element becomes larger.

2. The vibration damping device according to claim 1, wherein
a difference between the order of the vibration damping device when the amplitude of the vibration of the input torque is maximum and an excitation order of the engine is less than 50% of the excitation order.

3. The vibration damping device according to claim 1, wherein
a difference between the order of the vibration damping device when the amplitude of the vibration of the input torque is maximum and an excitation order of the engine is less than 20% of the excitation order.

4. The vibration damping device according to claim 1, further comprising:
a first guide portion that is provided in one of the support member, the restoring force generation member, and the inertial mass body and that extends along a radial direction of the support member; and
a second guide portion that is formed in one of two other than the one of the support member, the restoring force generation member, and the inertial mass body and that extends arcuately, wherein
the other of the two other than the one of the support member, the restoring force generation member, and the inertial mass body is guided by the first and second guide portions.

5. The vibration damping device according to claim 4, wherein
when a distance between a center of gravity of the restoring force generation member and a support point for swinging motion of the restoring force generation member along the second guide portion is defined as “L3”, a distance between the support point and the center of rotation is defined as “L4”, and the number of cylinders of the engine is defined as “n”, the following formula is met:
L3/(L3+L4)>α+β·n+γ
where “α”, “β”, and “γ” are each a constant determined in advance.

6. The vibration damping device according to claim 1, further comprising:
a first coupling shaft that couples the support member and the restoring force generation member so as to be rotatable relative to each other;
a second coupling shaft that is supported by one of the restoring force generation member and the inertial mass body and that couples the restoring force generation member and the inertial mass body so as to be rotatable relative to each other; and
a guide portion that is formed in the other of the restoring force generation member and the inertial mass body and that guides the second coupling shaft such that the second coupling shaft is swung about the first coupling shaft while keeping an interaxial distance between the first coupling shaft and the second coupling shaft constant, and such that the second coupling shaft is swung about a virtual third coupling shaft, a relative position of which with respect to the inertial mass body is determined to be invariable, while keeping an interaxial distance between the third coupling shaft and the second coupling shaft constant, along with rotation of the support member.

7. The vibration damping device according to claim 1, further comprising:
a connecting member rotatably coupled to the restoring force generation member via a second coupling shaft and rotatably coupled to the inertial mass body via a third coupling shaft.

8. The vibration damping device according to claim 6, wherein
when an interaxial distance between the center of rotation of the rotary element and the first coupling shaft is defined as “L1”, an interaxial distance between the first coupling shaft and the second coupling shaft is defined as “L2”, an interaxial distance between the second coupling shaft and the third coupling shaft is defined as “L3”, and an interaxial distance between the third coupling shaft and the center of rotation is defined as “L4”, the following formula is met:
L1+L2>L3+L4

9. The vibration damping device according to claim 8, wherein
when a distance from the first coupling shaft to a center of gravity of the restoring force generation member is defined as “Lg” and the number of cylinders of the engine is defined as “n”, the following formula is met:
L3/(L3+L4)>α·(Lg/L2)+β·n+γ
where “α”, “β”, and “γ” are each a constant determined in advance.

10. The vibration damping device according to claim 1, wherein
a reference order, which is a convergent value of the order of the vibration damping device when the amplitude of the vibration of the input torque transferred to the rotary element becomes smaller, is higher than an excitation order of the engine.

11. The vibration damping device according to claim 1, wherein
the support member rotates coaxially and together with a rotary element of a damper device that has a plurality of rotary elements that include at least an input element and an output element, and an elastic body that transfers torque between the input element and the output element.

12. The vibration damping device according to claim 11, wherein
the output element of the damper device is functionally coupled to an input shaft of a transmission.

13. A vibration damping device comprising:
a support member that rotates together with a rotary element, to which torque from an engine is transferred, about a center of rotation of the rotary element; a restoring force generation member that is coupled to the support member and that is swingable along with rotation of the support member; and
an inertial mass body coupled to the support member via the restoring force generation member and swung about the center of rotation in conjunction with the restoring force generation member along with rotation of the support member, wherein
the vibration damping device is designed such that an order of the vibration damping device is not varied even if an amplitude of vibration of input torque transferred from the engine to the rotary element is varied.

14. A vibration damping device comprising:
a support member that rotates together with a rotary element, to which torque from an engine is transferred, about a center of rotation of the rotary element;
a restoring force generation member that is coupled to the support member and that is swingable along with rotation of the support member; and
an inertial mass body coupled to the support member via the restoring force generation member and swung about the center of rotation in conjunction with the restoring force generation member along with rotation of the support member, the vibration damping device further comprising:
a first guide portion that is provided in one of the support member, the restoring force generation member, and the inertial mass body and that extends along a radial direction of the support member; and
a second guide portion that is formed in one of two other than the one of the support member, the restoring force generation member, and the inertial mass body and that extends arcuately, wherein:
the other of the two other than the one of the support member, the restoring force generation member, and the inertial mass body is guided by the first and second guide portions; and
when a distance between a center of gravity of the restoring force generation member and a support point for swinging motion of the restoring force generation member along the second guide portion is defined as “L3”, a distance between the support point and the center of rotation is defined as “L4”, and the number of cylinders of the engine is defined as “n”, the following formula is met:
L3/(L3+L4)>α+β·n+γ
where “α”, “β”, and “γ” are each a constant determined in advance.

15. A vibration damping device comprising:
a support member that rotates together with a rotary element, to which torque from an engine is transferred, about a center of rotation of the rotary element;
a restoring force generation member that is coupled to the support member and that is swingable along with rotation of the support member; and
an inertial mass body coupled to the support member via the restoring force generation member and swung about the center of rotation in conjunction with the restoring force generation member along with rotation of the support member, the vibration damping device further comprising:
a first coupling shaft that couples the support member and the restoring force generation member so as to be rotatable relative to each other;
a second coupling shaft that is supported by one of the restoring force generation member and the inertial mass body and that couples the restoring force generation member and the inertial mass body so as to be rotatable relative to each other; and
a guide portion that is formed in the other of the restoring force generation member and the inertial mass body and that guides the second coupling shaft such that the second coupling shaft is swung about the first coupling shaft while keeping an interaxial distance between the first coupling shaft and the second coupling shaft constant, and such that the second coupling shaft is swung about a virtual third coupling shaft, a relative position of which with respect to the inertial mass body is determined to be invariable, while keeping an interaxial distance between the third coupling shaft and the second coupling shaft constant, along with rotation of the support member, wherein
when an interaxial distance between the first coupling shaft and the second coupling shaft is defined as “L2”, an interaxial distance between the second coupling shaft and the third coupling shaft is defined as “L3”, an interaxial distance between the third coupling shaft and the center of rotation is defined as “L4”, a distance from the first coupling shaft to a center of gravity of the restoring force generation member is defined as “Lg”, and the number of cylinders of the engine is defined as “n”, the following formula is met:
L3/(L3+L4)>α·(Lg/L2)+β·n+γ
where “α”, “β”, and “γ” are each a constant determined in advance.

16. The vibration damping device according to claim 2, wherein
a difference between the order of the vibration damping device when the amplitude of the vibration of the input torque is maximum and an excitation order of the engine is less than 20% of the excitation order.

17. The vibration damping device according to claim 2, further comprising:
a first guide portion that is provided in one of the support member, the restoring force generation member, and the inertial mass body and that extends along a radial direction of the support member; and
a second guide portion that is formed in one of two other than the one of the support member, the restoring force generation member, and the inertial mass body and that extends arcuately, wherein
the other of the two other than the one of the support member, the restoring force generation member, and the inertial mass body is guided by the first and second guide portions.

18. The vibration damping device according to claim 2, further comprising:
a first coupling shaft that couples the support member and the restoring force generation member so as to be rotatable relative to each other;
a second coupling shaft that is supported by one of the restoring force generation member and the inertial mass body and that couples the restoring force generation member and the inertial mass body so as to be rotatable relative to each other; and
a guide portion that is formed in the other of the restoring force generation member and the inertial mass body and that guides the second coupling shaft such that the second coupling shaft is swung about the first coupling shaft while keeping an interaxial distance between the first coupling shaft and the second coupling shaft constant, and such that the second coupling shaft is swung about a virtual third coupling shaft, a relative position of which with respect to the inertial mass body is determined to be invariable, while keeping an interaxial distance between the third coupling shaft and the second coupling shaft constant, along with rotation of the support member.

19. The vibration damping device according to claim 2, further comprising:
a connecting member rotatably coupled to the restoring force generation member via a second coupling shaft and rotatably coupled to the inertial mass body via a third coupling shaft.

20. The vibration damping device according to claim 7, wherein
when an interaxial distance between the center of rotation of the rotary element and a first coupling shaft is defined as “L1”, an interaxial distance between the first coupling shaft and the second coupling shaft is defined as “L2”, an interaxial distance between the second coupling shaft and the third coupling shaft is defined as “L3”, and an interaxial distance between the third coupling shaft and the center of rotation is defined as “L4”, the following formula is met:
L1+L2>L3+L4
